(19) United States
(12) Patent Application Publication
(10) Pub. No.: US 2023/0402973 A1
(43) Pub. Date: Dec. 14, 2023

(54) System for Inspecting Photovoltaic Modules

(71) Applicant: Danmarks Tekniske Universitet, Kgs. Lyngby (DK)

(72) Inventors: Gisele Alves Dos Reis Benatto, Kgs. Lyngby (DK); Mingjun Chi, Kgs. Lyngby (DK); Peter Behrensdorff Poulsen, Kgs. Lyngby (DK); Paul Michael Petersen, Kgs. Lyngby (DK); Anders Kragh Hansen, Kgs. Lyngby (DK); Sergiu Spataru, Kgs. Lyngby (DK)

(21) Appl. No.: 18/249,472

(22) PCT Filed: Oct. 15, 2021
(86) PCT No.: PCT/EP2021/078713

§ 371 Date: Apr. 18, 2023

(30) Foreign Application Priority Data
Oct. 20, 2020 (EP) 20202838.7

(51) Int. Cl. H02S 50/15

(52) U.S. Cl. CPC H02S 50/15; H04N 23/56

(57) ABSTRACT

The present disclosure relates to an inspection system, in particular a mobile inspection system, for outdoor inspection of photovoltaic modules in situ, the inspection system comprising a movable detector unit and a processing unit. The detector unit is configured to obtain, when positioned at a user-controllable position spaced apart from a photovoltaic module of a photovoltaic power system, luminescence data from a light-receiving surface of said photovoltaic module. The detector unit may include a light source, in particular a laser source, configured to emit an illumination beam, means for selectively directing the illumination beam onto respective portions of the light-receiving surface so as, when the illumination beam is directed onto a first portion of the light-receiving surface, to only illuminate the first portion while leaving a corresponding first remaining portion of the light-receiving surface unilluminated by the illumination beam.

### TECHNICAL FIELD

The present disclosure relates to the inspection of photovoltaic (PV) modules in situ.

### BACKGROUND

Renewable energy is rapidly growing and with it, the requirement to make sure the energy production operates at maximum capacity. In the case of utility scale photovoltaics (PV), the energy-producing installations can cover several square kilometers. To maximize the energy yield and useful lifetime of photovoltaic (PV) plants it is necessary to identify cell or module failures in the field at the earliest possible stage before they cause significant power loss. It is thus desirable to be able to inspect such installations so as to be able to detect the operational state of the installation, in particular so as to detect defects of PV modules. Such inspection is normally time demanding or inaccurate. The most accurate PV defect detection techniques used today include the recording of I-V curves on a module level and electroluminescence (EL). However, these techniques require electrical contacting, which complicates or even prevents effective fault detection of large power plants.

In particular, EL of solar cells occurs when current is injected into the cell and radiative recombination of carriers causes light emissions, which peak at the wavelength corresponding to the energy of the bandgap of the solar cell semiconductor material. Capturing the emitted photons with a camera detector sufficiently sensitive to the luminescence peak wavelength is denoted EL imaging, and is one of the most precise solar cell and PV module failure detection techniques used today, in terms of types of failures and degradation that can be detected and high spatial resolution in characterizing the failure. However, the main drawback is that it requires electrical biasing of the PV module to load the cells. In practical terms, the process to connect a PV string to a power supply can correspond to 80% of the demanded time to inspect a PV installation using drones for the image acquisition.

U.S. Pat. No. 10,554,172 describes a system for outdoor inspection of PV modules. However, this prior system relies on sunlight as a source of illumination, thus rendering this technique dependent on weather conditions and unsuitable for use at night.

U.S. Pat. No. 9,641,125 describes an inspection system based on light-induced luminescence. In particular, this document describes an embodiment that is in physical contact with the front of the PV module.

US 2018/0159469 describes a system for line scanning of PV modules for obtaining luminescence data. In particular, this document describes a detector unit that is placed in physical contact with the PV module and the PV module is moved relative to the detector unit. The detector includes a light source and a line camera that is moved across the module together with the light source.

However, it remains desirable to provide an efficient implementation of a laser luminescence imaging system suitable for large-scale outdoor inspection of PV modules. In particular, it is desirable to provide a system that can be manufactured at relatively low costs. It is further desirable to provide a reliable system. It is further desirable to provide a durable system. It is further desirable to provide a system whose operation is relatively insensitive to weather and/or ambient light conditions. It is further desirable to provide a system that can efficiently inspect large PV installations. It is further desirable to provide a system that allows accurate detection of various types of defects occurring in PV modules.

### SUMMARY

It is an object of the present disclosure to provide an inspection system for outdoor inspection of PV modules, in particular an inspection system that solves one or more of the problems identified above or that at least may serve as an alternative to known systems.

According to one aspect, disclosed herein are embodiments of an inspection system, in particular a mobile inspection system, for outdoor inspection of photovoltaic modules in situ, in particular whilst the photovoltaic modules are connected in a PV string. The inspection system comprises a movable detector unit and a processing unit; wherein the detector unit is configured to obtain, when positioned at a user-controllable position spaced apart from a photovoltaic module, luminescence data from a light-receiving surface of said photovoltaic module; the detector unit comprising:
a light source, in particular a laser source, configured to emit an illumination beam;
means for selectively directing the illumination beam onto respective portions of the light-receiving surface so as, when the illumination beam is directed onto a first portion of the light-receiving surface, to only illuminate the first portion while leaving a corresponding first remaining portion of the light-receiving surface unilluminated by the illumination beam and, when the illumination beam is directed onto a second portion of the light-receiving surface, to only illuminate the second portion while leaving a corresponding second remaining portion of the light-receiving surface unilluminated by the illumination beam;
an imaging system configured to capture a plurality of images of the light-receiving surface, the plurality of images including a first image captured while only the first portion is illuminated by the illumination beam and depicting at least a part of the first illuminated portion and at least a part of the unilluminated first remaining portion, the plurality of images further including a second image captured while only the second portion is illuminated by the illumination beam and depicting at least a part of the second illuminated portion and at least a part of the unilluminated second remaining portion;
   wherein the processing unit is configured to process the plurality of images to provide reconstructed image data indicative of luminescence emitted by the light-receiving surface responsive to respective portions of the light-receiving surface being illuminated by the illumination beam.

Accordingly, embodiments of the system obtains and utilizes first image data indicative of photoluminescence emitted by illuminated portions of the photovoltaic module when said illuminated portions are selectively illuminated by the illumination beam, i.e. when the light-receiving surface is only partially illuminated by the illumination beam. For the purpose of the present description the first image data indicative of photoluminescence will also be referred to as PL image data. The photoluminescence emitted by the illuminated portions is primarily determined by the optical properties of the solar cell absorber material. The system further obtains and utilizes second image data, indicative of induced luminescence emitted by unilluminated portions, while other portions of the light-receiving surface are selectively illuminated by the illumination beam, i.e. induced luminescence emitted by unilluminated solar cell portions, while the light-receiving surface is only partially illuminated by the illumination beam. The induced luminescence is primarily determined by a combination of the optical and electrical properties of the solar cell and its conductive regions. For the purpose of the present description the second image data, indicative of induced luminescence, will also be referred to as contactless EL image data. In particular, induced luminescence occurs in the unilluminated portions of a partially illuminated PV cell. Induced luminescence is limited to partially illuminated cells.

Accordingly, embodiments of the inspection system described herein are configured to only partially illuminate the crystalline silicon solar cells at any point in time, while leaving remaining portions unilluminated. For example, the inspection system may use a line illumination or it may illuminate a 2D spot or pattern, e.g. using a circular or elliptical laser beam or another form of illumination spot covering a portion of the light-receiving surface of a photovoltaic module. To this end, the inspection system may be configured to emit a divergent illumination beam. The divergence may be chosen such that the beam creates a spot of a desired shape and size on the light-receiving surface of the PV module when the apparatus is at a suitable distance from the PV module. Accordingly, photoluminescence is recorded where the light excitation signal is located.

In some embodiments, the light source and/or the means for selectively directing the illumination beam onto respective portions of the light-receiving surface are configured to direct a collimated beam onto the light receiving surface. In other embodiments, the light source and/or the means for selectively directing the illumination beam onto respective portions of the light-receiving surface are configured to direct a diverging beam onto the light receiving surface or otherwise directing the illumination beam onto respective portions of the light-receiving surface as an illuminated spot, in particular a 2D spot or pattern. The inventors have realized that a slightly divergent beam illuminating a 2D spot or pattern can improve the acquisition of a high quality PL image in addition to a high quality contactless EL image. Moreover, a divergent illumination may be beneficial for eye-safety and simplify the optical system.

In some embodiments, the inspection system is configured to illuminate a 2D spot or pattern having a diameter of at least 1 cm, such as at least 2 cm, such as at least 3 cm. The diameter may be selected small enough to ensure that only a portion of a PV cell is illuminated by the 2D spot or pattern. For example, the diameter may be less than 10 cm, such as less than 8 cm, such as less than 6 cm. Here, the diameter of the spot may be defined by the diameter of the smallest circle enclosing the 2D spot or pattern. When the 2D spot or pattern is elongated, the 2D spot or pattern may have a length defined along the axis of elongation and a width defined in a direction normal to the axis of elongation. In such an embodiment, the width may be at least 1 cm, such as at least 2 cm, such as at least 3 cm. The width may be selected small enough to ensure that only a portion of a PV cell is illuminated by the 2D spot or pattern. For example, the width may be less than 10 cm, such as less than 8 cm, such as less than 6 cm. The length may also be at least 1 cm, such as at least 2 cm, such as at least 3 cm. However, the length may be considerably larger, e.g. larger than 10 cm. It may even be larger than the dimension of a PV cell and partly or completely extend across two or even more PV cells, e.g. across an entire panel having multiple cells, such as 10×6 cells. The dimensions of the spot or pattern, in particular the diameter, the width and/or the length discussed above may be defined as the respective FWHM along the respective directions.

Simultaneously, part of the energy generated by the illumination beam generates induced luminescence that can be measured in the remaining unilluminated portions of the cell, due to its very efficient lateral current spreading. Individual images of the plurality of captured images include the first image data and the second image data. However, different images of the plurality of images include first image data pertaining to respective portions of the light-receiving surface, and different images of the plurality of images include second image data pertaining to respective portions of the light-receiving surface. The processing unit generates at least one reconstructed image combining first and/or second image data included in respective ones of the plurality of images into a single reconstructed image. It will be appreciated that the processing unit may generate multiple reconstructed images, each such that different reconstructed images represent different combinations of first and second image data. In some embodiments, the processing unit is configured to process each of the plurality of captured images to separate first image data from second image data from each of the images.

Consequently, a large variety of defects may be detected based on the first and second image data, in particular since some types of defects are detectable, or at least more easily detectable, based on photoluminescence data provided by the first image data, while other types of defects are detectable, or at least more easily detectable, based on induced luminescence data provided by the second image data. Additionally, further types of defects are detectable, or at least more easily detectable, based on the combination of photoluminescence and contactless electroluminescence data.

Moreover, as image data indicative of photoluminescence and of induced luminescence are obtained concurrently, in particular during a single scan or sweep of the illumination beam across the surface of the PV module, and without the need for applying electrical power to the PV modules or otherwise altering the electrical connections of the PV module, an efficient in situ inspection of PV modules is achievable, in particular even while the PV modules are connected in a PV string. To this end, embodiments of the inspection system disclosed herein may direct an illumination beam of laser light onto the light-receiving surface of the solar cells of a PV module, the laser beam illuminating an area, e.g. in the form of a line, a spot, an ellipsis, or another form/shape of illuminated pattern, causing photo-excited excess carriers and radiative recombination in the illuminated portion, as well as current flow to the non-illuminated portions with corresponding induced luminescence emissions. The inspection system may sweep or scan the illuminated area across the light-receiving surface and capture images of the light-receiving surface with different parts of the light-receiving surface being illuminated. The inspection system can thus make use of the diagnostic information of both photoluminescence and the induced luminescence during a single light scan and it can characterize cell cracks and crystallographic defects, but also broken contact fingers and/or broken ribbons, increased series resistance areas, cracked, partially or fully disconnected cell regions, as well as shunted cells or cell regions.

The, or each, reconstructed image may reflect photoluminescence or induced luminescence data or both. For example, the processing unit may generate a first reconstructed image indicative of photoluminescence of respective portions of the light-receiving surface when illuminated by the illumination beam. Alternatively or additionally, the processing unit may generate a second reconstructed image indicative of induced luminescence emitted by respective surface portions when unilluminated but responsive to other surface portions being illuminated by the illumination beam.

At least some embodiments of the inspection system allow inspection to be performed during daylight and nighttime and during varying weather conditions. Yet further, the inspection does not require equipment to be attached or otherwise be connected to the photovoltaic modules. In particular, the inspection can be performed fully contactless, as the PV cells of the PV module under inspection are energized by the illumination beam emitted by the external light source, external to the PV module. The illumination beam excites the excess carriers of the PV cells of the PV module and causes radiative recombination and luminescence.

The detector unit does not need to be in physical contact to the PV module being inspected and is preferably not in contact with the PV module, thereby allowing increased flexibility in positioning the detector unit and a more efficient inspection. The detector unit may be positioned at a distance from the PV module being inspected, e.g. more than 1 m apart from the light-receiving surface of the PV module, e.g. as measure from the output aperture of the light source, in particular the laser source. In some cases, the detector unit may be positioned more than 2 m apart from the light-receiving surface of the PV module, such as more than 3 m, such as more than 5 m.

Embodiments of the inspection system disclosed herein are suitable for in situ inspection of PV modules, i.e. for inspecting the PV modules at the location where the PV modules are installed for energy production, in particular in a photovoltaic power system, without the need for repositioning the PV module to a special test facility and/or without the need for electrically disconnecting the PV module from other components of the photovoltaic power system, e.g. from one or more other PV modules and/or from an inverter. In particular, in situ inspection of PV modules may be performed while the PV modules are electrically interconnected with one or more other PV modules to form a PV string of PV modules, i.e. in situ inspection of PV modules that are interconnected to other PV modules may be performed without the need for disconnecting the PV modules from the other PV modules prior to inspections. The inspection system disclosed herein does not require that the PV modules are being completely or partially covered against ambient light or daylight during the acquisition of the image data.

Embodiments of the inspection system disclosed herein are suitable for outdoor inspection of photovoltaic modules, i.e. without the need for repositioning the PV modules to be inspected to an indoor location. At least some embodiments of the inspection system disclosed herein are suitable for inspection during daylight. It will be appreciated, however, that embodiments of the inspection system disclosed herein may also be used for indoor inspection and/or for inspection of PV modules at locations other than the photovoltaic power system.

In some embodiments, the detector unit is mountable on a tripod or other movable support structure. Accordingly, an operator may position the detector unit at a distance from a photovoltaic module to be inspected. The detector unit may capture a series of images of the photovoltaic module while scanning or sweeping the illumination beam across the light receiving surface of the photovoltaic module. The operator may then move the detector unit and tripod to a different position so as to inspect a different photovoltaic module.

In some embodiments, the detector unit is mounted on a vehicle, e.g. a ground vehicle or an aerial vehicle. The vehicle may be self-propelled. The vehicle may be remote-controllable and/or it may be autonomous or semi-autonomous. Examples of a ground vehicle include a small car, dolly or other wheel-driven vehicle that may be movable on the ground, optionally along tracks, e.g. self-propelled or by being pushed, pulled or otherwise propelled by an operator. Examples of an aerial vehicle include an unmanned aerial vehicle, also referred to herein as a drone. Examples of a drone include a remote-controllable quadcopter or hexacopter.

The illumination beam may be directed to respective portions of the light receiving surface of a PV module in a number of ways. In one embodiment, the detector unit includes a movable, such as a rotatable mirror or other reflective or refractive element configured to redirect the illumination beam emitted by the laser towards different directions. Accordingly, the detector unit may control the movable reflective or refractive element so as to cause the detector unit to direct the illumination beam towards respective portions of the light-receiving surface of the PV module under inspection while the position and orientation of the detector unit and, in particular, the position and orientation of the imaging system may remain substantially stable relative to the PV module.

Alternatively or additionally, the detector unit may include a frame, housing or other reference structure defining a position and orientation of the detector unit. The detector unit may further comprise a movable member, movable relative to the frame, housing or other reference structure. The light source, in particular the laser source, and, optionally, the imaging system may be mounted onto the movable member. The detector unit may comprise a control unit and a drive unit. The drive unit may be configured to cause movement, such as rotation and/or tilt and/or pan movement, of the movable member relative to the frame, housing or other reference structure. The control unit may be configured to control the drive unit. Accordingly, the detector unit may control the movable element so as to cause the light source, in particular the laser source, to direct the illumination beam towards respective portions of the light-receiving surface of the PV module under inspection while the position of the detector unit may remain substantially stable relative to the PV module.

Yet alternatively or additionally, the illumination beam may be directed to respective portions of the light-receiving surface of the PV module by controlling movement, in particular movement relative to the PV module, of the detector unit as a whole, e.g. by controlling movement of a vehicle or other support structure on which the detection unit is mounted.

The imaging system may comprise a camera detector sufficiently sensitive to the luminescence peak wavelength emitted by the semiconductor material of the PV module. For example, the imaging system may include a Short Wavelength InfraRed (SWIR) sensitive camera detector, e.g. an InGaAs camera detector. The luminescence peak wavelength of the semiconductor material of the PV module corresponds to the energy of the bandgap of the semiconductor material. In some embodiments the camera detector is configured to record light at least in a detection wavelength range where the detection wavelength range lies within a range of between 900 nm and 1700 nm, such as between 1000 nm and 1500 nm, such as between 1050 nm and 1250 nm, such as between 1100 nm and 1200 nm. In some embodiments, the imaging system comprises an optical filter configured to selectively allow radiation of at least a first wavelength range pass towards the camera detector. The optical filter may be a bandpass filter configured to only allow radiation of a first wavelength range pass towards the camera detector. Accordingly, the first wavelength range may have an upper limit and a lower limit. Alternatively, the optical filer may be a longpass filter, i.e. the first wavelength range may have a lower limit but be upwardly unconstrained. For example, the longpass filter may selectively allow radiation having a wavelength larger than 900 nm, such as larger than 1000 nm to pass. It will be appreciated that the optical filer may also be another type of filter that can block the laser beam and, optionally, visible light. Blocking visible light may be particularly useful in embodiments where the camera detector also detects light in the visible range and where inspection is desirable to be performed during daylight. The first wavelength range may be selected to match the luminescence peak wavelength of the semiconductor material. In some embodiments, the first wavelength range is between 900 nm and 1500 nm, such as between 1000 nm and 1500 nm, such as between 1050 nm and 1250 nm, such as between 1100 nm and 1200 nm. Accordingly, in some embodiments the camera detector of the imaging system is predominantly sensitive in the near-infrared region of the electromagnetic spectrum. The detection range of the camera detector may be even broader, such as between 600 nm and 1700 nm.

In some embodiments, the light source, in particular the laser source, is configured to emit an illumination beam having a wavelength different from, in particular shorter than, the luminescence peak wavelength of the semiconductor material of the PV module. For example, the wavelength of the illumination beam may be in the visible, such as red, part of the electromagnetic spectrum or in the near-infrared part of the electromagnetic spectrum. The imaging system may include an optical filter configured to block radiation at the wavelength of the illumination beam while allowing wavelengths at the luminescence peak wavelength of the semiconductor material of the PV module pass. For example, the transmission rate of the optical filter at the luminescence peak wavelength of the semiconductor material may be 70% or higher.

For example, in some embodiments, in particular when the inspection system is to be operated at nighttime or indoors, the imaging system may be exposed to light at the wavelength of the illumination beam and/or to other ambient light, e.g. indoor or outdoor illumination systems. When the detector of the imaging system is sensitive at the wavelength of the illumination beam and/or of other illumination systems, the optical filter is preferably configured to block light at a blocking wavelength range that includes the laser wavelength and/or the wavelength(s) of possible visible surrounding light. The optical filter is preferably further configured to allow light at the luminescence range of the semiconductor material (e.g. in the range between 900 nm and 1300 nm for the crystalline silicon) and, in particular, at the luminescence peak wavelength of the semiconductor material pass with a sufficiently high transmission rate, e.g. 70% or higher. Preferably, the optical density (OD) of the optical filter at the blocking wavelength range is OD 4 or higher, such as OD 6 or higher.

In some embodiments, in particular when the inspection system is to be operated outdoors during daytime, the imaging system may further be exposed to daylight in addition to being exposed to the illumination beam from the light source. When the detector of the imaging system is sensitive at the wavelengths of daylight, the optical filter is preferably configured to block light at a blocking wavelength range that includes the wavelengths of the daylight to which the detector is sensitive, other than the luminescence range of the semiconductor material or at least the luminescence peak wavelength of the semiconductor material. This may be in addition to the optical filter being configured to block the wavelength of the illumination beam, at least if the detector is sensitive at that wavelength. In an outdoor and daytime application, the preferred optical density of the optical filter may depend of the sunlight intensity during which inspection is to be performed. Preferably the optical density of the optical filter in the blocking wavelength range is OD 4 or higher. When operation of the inspection system in overcast weather, e.g. at approximately 100 W/m 2 sun irradiance or lower, the optical density of the optical filter in the blocking wavelength range is preferably selected to be OD 10 or higher, such as OD 12 or higher. The transmittance of the optical filter in a 25 nm band around the peak of the luminescence spectrum of the semiconductor material is preferably at least 90%, such as at least 94%. For higher sun irradiances, higher optical densities in the blocking wavelength range may be desirable, such as OD 15 or higher or even OD 20 or higher. High optical densities at the blocking wavelength range may e.g. be obtained by stacking multiple optical filters with moderate optical density at the blocking range and high total transmittance. For example an optical density of OD 20 may be obtained by stacking five OD 4 filters with 90% total transmittance.

In some embodiments, the detector unit is configured to capture at least one image prior to activating the illumination beam, e.g. prior to switching on the light source or prior to opening a shutter of the light source. The image captured prior to activating the illumination beam may be captured by the imaging system or by an additional camera of the detector unit, e.g. by a visual camera sensitive to radiation in the visual part of the electromagnetic spectrum. The detector unit may further be configured to process the captured image so as to recognize a PV module in the field of view of the imaging system or of the additional camera and/or so as to detect one or more other objects within the field of view of the imaging system or of the additional camera. The detector unit may be configured to only activate the illumination beam, e.g. to only switch on the light source and/or to only open a shutter of the light source, in response to recognizing a PV module in at least a portion of said field of view which is to be illuminated by the illumination beam and/or responsive to not detecting other objects, different from a PV module, at least in the portion of said field of view, which is to be illuminated by the illumination beam. It will be understood that activation of the illumination beam may alternatively or additionally be conditioned on other conditions, e.g. dependent on an input by an operator.

In some embodiments, the detector unit may comprise a visual camera, i.e. a camera sensitive in at least a part of the visible part of the electromagnetic spectrum, i.e. in the range between 300 nm and 800 nm, such as between 400 nm and 700 nm. Accordingly, the detection of the position and orientation of the PV module relative to the detector unit is facilitated even prior to activating the light source, thus facilitating positioning the detector unit prior to activating the light source and/or facilitating selective activation of the light source only when the detector unit is properly positioned and the field of view unobstructed. The positioning may be performed or at least verified by an operator. To this end one or more images captured by the visual camera may be displayed on a display of a control panel, e.g. on a display of a suitably programmed portable computer, such as a laptop computer or tablet computer. The control panel may be communicatively coupled to the detector unit, e.g. by a wireless or wired connection. In some embodiments, the control panel may even be integrated into the detector unit. Alternatively or additionally to a manual positioning by an operator, the inspection system may be configured to automatically position the detector unit, e.g. by automatically controlling movements of a ground vehicle or aerial vehicle. In some embodiments a manual positioning may be combined with an automatic position control. For example the inspection system may be configured to control a ground vehicle or aerial vehicle carrying the detector unit to maintain an operator-selected position relative to a PV module, and/or to follow a predetermined motion path relative to a PV module, e.g. so as to sweep the illumination beam across the light-receiving surface of the PV module. An automatic position and/or an automatic control of an operator-selected position, and/or an automatic movement along a predetermined motion path may be based on an automatic image processing of the captured images of the visual camera, optionally in combination with other positioning signals, such as GPS signals.

Alternatively or additionally, during operation of the light source and the capturing of images of the PV module by the imaging system, the detector unit may be configured to process at least a subset of the captured images by the imaging system—or to capture additional images by the additional camera as described herein—so as to recognize the PV module in the field of view of the imaging system and/or so as to detect one or more other objects within the field of view of the imaging system. The detector unit may be configured to deactivate the illumination beam, e.g. by switching off the light source or by operating a shutter of the light source, responsive to a failure to recognize a PV module in the field of view of the imaging system and/or responsive to detecting other objects, different from a PV module, in the field of view of the imaging system or at least in a portion of the field of view illuminated by the illumination beam.

In some embodiments, the laser source comprises a laser diode, such as a broad-area diode or a tapered laser diode. The laser source may be configured to emit an illumination beam having a wavelength of between 700 nm and 900 nm, such as between 740 nm and 850 nm, such as about 808 nm. The laser source may have an output power sufficient for providing a suitable irradiance of the PV module, e.g. at least 1 W, such as at least 10 W, such as at least 20 W, such as at least 50 W, such as at least 100 W, such as at least 200 W output power, such as at least 250 W output power. It will be appreciated that suitable power levels may depend on a variety of factors, such as: distance between the laser and panel, effective cell and module area illuminated by the laser, laser beam properties and the distance between the detector unit, laser wavelength, ambient noise (light) and the PV module properties. The laser output power may be selected low enough so as to allow safe operation and low enough so as to avoid physical damage of the PV module.

In some embodiments, the homogeneity of the beam may be 20% or higher, or even 40% or higher, throughout the beam or the scanned area. One embodiment of the laser source provides a laser beam that has an intensity, which varies no more than 12% with the scanning angle. The beam quality as expressed by the M² value (e.g. as measured according to ISO 11146) should preferably be less than 20. In any event, in some embodiments, a variability of the illumination beam may be compensated for in the subsequent image processing. To this end, the inspection system may subjected to a suitable calibration procedure. For example, the calibration process may include illuminating a reflective surface with the illumination beam and capturing one or more images of the illuminated reflective surface by the imaging system while avoiding saturation at any point of the image. The thus acquired images may be used to compute a 2D intensity profile indicative of the spatial inhomogeneity of the laser illumination of the illuminated area. The thus obtained intensity profile may be used to calibrate the image processing for the light-induced luminescence scanning. For angular scanning, an image of the beam in different positions of the scan may be necessary. Other inputs that might be used for the calibration may include one or more of the following: the distance from the light source to the sample, the laser optical power (e.g. as measured with a power meter at multiple—e.g. five or more—points of the beam hitting the surface. The thus acquired images and/or calibration parameters may be made once for a particular light source and used as laser beam properties input for the image processing algorithm to know when the luminescence is more intense because of a more intense section of the beam and not because of PV panel defects or properties.

In some embodiments, the laser source is configured to emit a 1- or two dimensional or 2-dimensional laser light pattern, e.g. in the form of structured laser light, a line laser, a dot/circular laser rectangular, elliptical and/or the like. Here, the term 1-dimensional pattern is intended to refer to a line or other pattern substantially having an extent only in a single direction. The illuminated pattern may have a top-hat, Gaussian illumination profile or other form of illumination profile. In some embodiments, the system is configured to illuminate multiple separate areas at the same time, in particular multiple non-overlapping and spaced apart areas.

In some embodiments, the light source is configured to emit pulsed light, in particular pulsed laser light. The pulsing may be performed by rapidly switching the laser source, e.g. a laser diode, on and off. The emitted light pulses may have a pulse rate and pulse width corresponding to the frame rate and exposure time of the camera. In particular the light pulses may be synchronized with the exposures of the camera and the pulse width may be selected such that it corresponds to the exposure time of the camera. Accordingly, a high peak illumination power may be achieved with relatively low average output power of the laser. This increases the resulting image quality while reducing the power requirements of the laser. Moreover, this increases safety of the system. In some embodiments, it is preferred that the exposure time of the camera may be selected to be equal to, or slightly shorter than, the pulse width of the laser so as to improve the signal-to-noise ratio of the signals captured by the camera. Nevertheless, in other embodiments, the exposure time may be equal to or even larger than the pulse width of the laser.

In some embodiments, the detector unit and/or a vehicle on which the detector unit is mounted, includes a positioning system, e.g. a GPS system. And the detector unit is configured to associate positioning data to the captured images, so as to allow matching the captured images with known positions of respective PV modules within a PV facility. To this end, the inspection system may have stored thereon, or at least have access to, suitable reference data, such as a reference map of the PV facility, indicative of positions of the PV modules to be inspected, thus allowing associating the reconstructed images and/or other inspection results with specific PV modules of the PV facility.

In some embodiments, the detector unit is configured to scan the PV module with the illumination beam. To this end, the camera detector (e.g. the InGaAs camera) is configured to acquire a sequence of images coordinated with the beam scanning speed. The scanning speed and detector frame rate may vary depending of the level of ambient light noise, expected inspection speed, image processing speed, PV diagnosis goals, among others.

In some embodiments, the detector unit is configured to repeatedly scan the PV module with the illumination beam, e.g. using respective power levels. Accordingly, as some types of PV cell failures may be more easily detectable at different levels of induced currents, an improved fault detection may be achieved.

The processing unit may be integrated into the detector unit, e.g. provided as an on-board processing unit integrated into the movable detector unit, i.e. the movable detector unit and the processing unit may be provided integrated into a single housing. Alternatively, all or a part of the processing unit may be embodied as a processing unit separate from the detector unit, in particular physically separated and located in a proximity or even far away from the movable detector unit. In particular all or a part of the processing unit may be located indoors. For example, to this end, the detector unit may be configured to store the captured images on a storage medium of the detector unit for subsequent retrieval and analysis by a separate processing unit. Alternatively or additionally, the detector unit may comprise a wired or wireless communications interface, such as a wireless transmitter, e.g. a radio transmitter, configured to transmit the captured images to a processing unit external to the detector unit. The transmission may be performed during the inspection, e.g. in real-time or quasi real-time. Alternatively the transmission may be performed after completion of the inspection.

Generally, the processing unit may include a suitably programmed microprocessor or any other circuit and/or device suitably adapted to perform the data- and/or signal-processing functions described herein. In particular, the processing unit may comprise a general- or special-purpose programmable microprocessor, such as a central processing unit (CPU), a digital signal processing unit (DSP), an application specific integrated circuit (ASIC), a programmable logic array (PLA), a field programmable gate array (FPGA), a Graphical Processing Unit (GPU), a special purpose electronic circuit, etc., or a combination thereof. To this end, the processing unit may be suitably programmed by software and/or firmware configured to be executed by the processing unit. The software and/or firmware may be stored on a suitable memory of the processing unit. In some embodiments, the processing unit is a suitably programmed computer or other data processing system.

The present disclosure relates to different aspects, including the inspection system described above and in the following, further methods, systems, devices and product means, each yielding one or more of the benefits and advantages described in connection with one or more of the other aspects, and each having one or more embodiments corresponding to the embodiments described in connection with one or more of the other aspects described herein and/or as disclosed in the appended claims.

In particular, according to one aspect, disclosed herein are embodiments of a method for outdoor inspection of photovoltaic modules in situ, in particular whilst the photovoltaic modules are connected in a PV string. The method comprises:
positioning a detector unit spaced apart from a photovoltaic module;
selectively directing an illumination beam emitted by a light source of the detector unit onto respective portions of the light-receiving surface so as, when the illumination beam is directed onto a first portion of the light-receiving surface, to only illuminate the first portion while leaving a corresponding first remaining portion of the light-receiving surface unilluminated by the illumination beam and, when the illumination beam is directed onto a second portion of the light-receiving surface, to only illuminate the second portion while leaving a corresponding second remaining portion of the light-receiving surface unilluminated by the illumination beam;
capturing, by an imaging system of the movable detector unit, a plurality of images of the light-receiving surface, the plurality of images including a first image captured while only the first portion is illuminated by the illumination beam and depicting at least a part of the first illuminated portion and at least a part of the unilluminated first remaining portion, the plurality of images further including a second image captured while only the second portion is illuminated by the illumination beam and depicting at least a part of the second illuminated portion and at least a part of the unilluminated second remaining portion;
processing the plurality of images to provide reconstructed image data indicative of luminescence emitted by the light-receiving surface responsive to respective portions of the light-receiving surface being illuminated by the illumination beam.

### BRIEF DESCRIPTION OF THE DRAWINGS

The above and other aspects will be apparent and elucidated from the embodiments described in the following with reference to the drawing in which:

FIG. 1 schematically illustrates an example of an inspection system for outdoor, in situ inspection of PV modules.

FIG. 2 schematically illustrates another example of an inspection system for outdoor, in situ inspection of PV modules.

FIG. 3 schematically illustrates yet another example of an inspection system for outdoor, in situ inspection of PV modules.

FIG. 4 schematically illustrates yet another example of an inspection system for outdoor, in situ inspection of PV modules.

FIG. 5 schematically illustrates an example of a detector unit of an inspection system for outdoor, in situ inspection of PV modules.

FIG. 6 illustrates different spectral distributions involved in inspection of PV modules.

FIG. 7 shows a flow diagram of a method for processing the images captured by a detector unit described herein.

FIG. 8 schematically illustrates steps of a method for processing the images captured by a detector unit described herein.

FIGS. 9A-B show examples of image data reconstructed from the acquired images by an embodiment of the system described herein.

FIGS. 10A-B, 11A-B and 12 illustrate image processing steps performed by an embodiment of the inspection system disclosed herein.

FIGS. 13A-C show examples of image data reconstructed from the acquired images by an embodiment of the system described herein.

FIG. 14 shows another example of image data reconstructed from acquired images by an embodiment of the system described herein.

FIG. 15 schematically illustrates another example of an inspection system for outdoor, in situ inspection of PV modules.

FIGS. 16A-B and 17 schematically illustrate examples of the laser control of an embodiment of the system described herein.

FIG. 18 illustrates an example of a partially illuminated PV module.

FIG. 19 illustrates an example of a reconstructed PL image.

FIG. 20 illustrates an example of a reconstructed contactless EL image.

FIG. 21 illustrates a comparative example of a conventional EL image.

FIGS. 22A and 22B illustrate an example of a partially illuminated PV module.

FIGS. 23A and 23B illustrate a recorded light intensity along a line across the partially illuminated light-receiving surface of an image captured as described in connection with FIGS. 22A and 22B.

FIGS. 24A and 24B illustrate outdoor operation of the system of FIG. 15.

### DETAILED DESCRIPTION

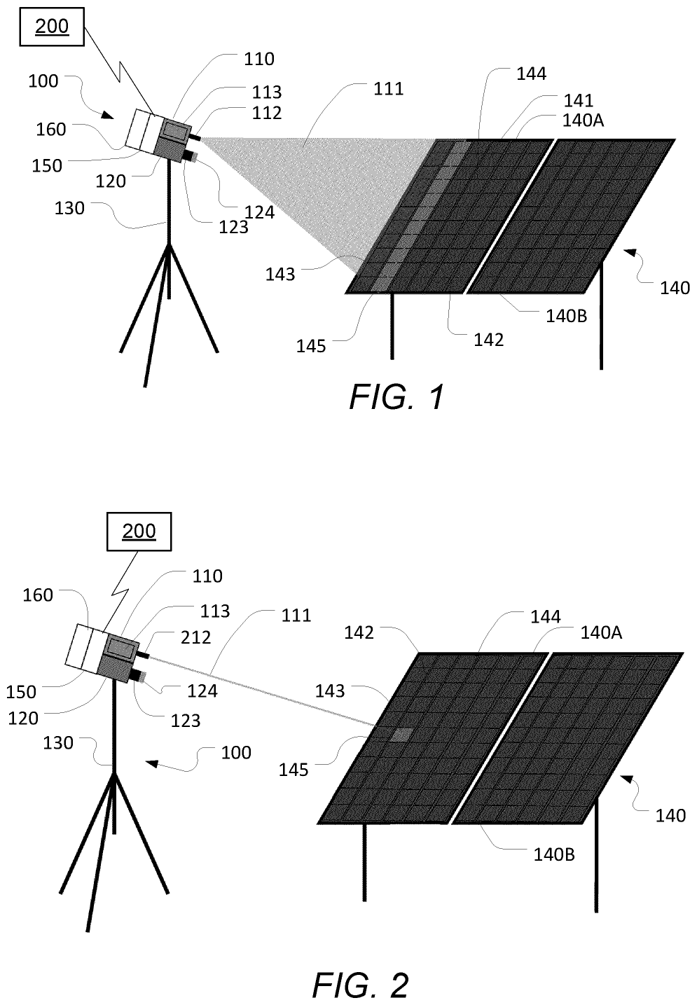

FIG. 1 schematically illustrates an example of an inspection system for outdoor, in situ inspection of PV modules. In particular, FIG. 1 schematically illustrates a PV unit 140. The PV unit 140 comprises two PV modules 140A and 140B, respectively. Each PV module comprises a plurality of PV cells 141. The term PV module generally refers to a field-installable unit, which may be pre-wired and mountable on a suitable support structure, such as a frame. For ease of illustration, FIG. 1 as well as the subsequent figures only depict two single PV modules. It will be appreciated, however, that other examples of PV energy production facilities include multiple such PV modules, such as tens, hundreds or even thousands of such PV modules, which may be arranged across an extended area, e.g. arranged in an array of PV modules. The PV modules may be mounted individually or combined into larger units. Embodiments of the inspection system disclosed herein are particularly well suited for such larger PV energy production facilities where multiple PV modules are to be inspected.

Generally, a PV cell is a semiconductor device configured to convert light into electricity. A plurality of PV cells 141 are typically electrically configured into prewired PV modules 140A,B. In particular each PV module may include an array of PV cells, such as several tens of PV cells. The PV cells may be arranged in an array or other suitable arrangement such that the PV module defines a light-receiving surface 142. Generally, PV modules typically include electrical conductors, typically formed as a grid-like metallic structure made up of so-called “fingers” and larger so-called “busbars”. The busbars typically form parallel rows of conductors. The fingers typically form parallel rows of conductors arranged perpendicular to the busbars and feeding into the busbars. The fingers and busbars conduct the direct current the cells collect from solar photons such that the current can flow into a solar inverter, which converts the direct current into useable alternating current.

One or more of such PV modules may then be assembled as a pre-wired, field-installable PV unit. In particular multiple PV modules, such as more than 10 PV modules, may be interconnected to form a PV string of PV modules. The PV string may be connected to an inverter. While FIG. 1 illustrates a unit 140 with two PV modules, it will be appreciated that embodiments of the inspection system disclosed herein may equally be used for the inspection of PV units that only include a single PV module or PV units that include more than two PV modules.

The monitoring system of FIG. 1 comprises a detector unit, generally designated 100. The detector unit comprises a laser source 110 and an imaging system 120.

The laser source 110 may comprise a diode laser 113 and the imaging system 120 may comprise a digital camera, in particular a SWIR sensitive camera, such as an InGaAs camera. The imaging system may comprise an optical system including one or more lenses 123 and an optical filter 124. The imaging system may be configured to acquire a sequence of discrete images or a continuous or quasi-continuous video stream.

The laser source 110 is configured to emit an illumination beam 111 along an illumination beam path configured to selective illuminate respective portions 143 of the light-receiving surface 142 of the PV module to be inspected at a time while leaving a remaining portion 144 of the module unilluminated. In the example of FIG. 1, the laser source is configured to emit an illumination beam configured to form a laser-line on the surface of the PV module. Accordingly, the illuminated portion 143 has the form of a narrow stripe, i.e. a line. It will be appreciated that, in other embodiments, the laser source may be configured to emit another form of structured laser light and/or laser beam illuminating a 2D spot or pattern, such as a circle, an elongated spot, an ellipses, a rectangle etc. The laser source may be configured to emit a laser-line having a suitably chosen fan angle, such as between 20° and 40°, e.g. about 30°. It will be appreciated that the fan angle may be selected based on the dimensions of the PV modules to be inspected and the distance at which the detector unit is positioned from the PV modules. Generally, alternative embodiments of the inspection system disclosed herein may utilize other types of light sources, e.g. LED based light sources or superluminescent diodes.

The detector unit further comprises of means for selectively directing the illumination beam onto respective portions of the light-receiving surface. In particular, in the example of FIG. 1, the detector unit comprises a rotatable mirror 112 that is rotatable around an axis of rotation allowing the illumination beam to be redirected into different directions so as to sweep the laser beam across the light-receiving surface of a PV module. It will be appreciated that the rotatable mirror 112 may be accommodated inside a housing of the detector unit. In the example of FIG. 1, the laser-line extends parallel to the module bus bars of the PV module. However, in alternative embodiments, the detector unit may be configured to provide an illuminated laser-line on the surface of the PV module such that the illuminated line extends perpendicular to the bus bars of the PV module, or in a different direction. In the example of FIG. 1, the detector unit is configured to sweep the laser beam along a sweep direction that extends perpendicular to the longitudinal extent of the laser line 143. It will be appreciated that, instead of employing a one-axis laser scanning mirror, the detector unit may include different means for redirecting the illumination beam. For example, the laser source may be mounted movably, e.g. rotatably, on a multi-axis robot arm, or slidably along a track or rail in order to allow sweeping the laser beam across the light-receiving surface of the PV module.

The detector unit 150 comprises a control unit 150 for controlling operation of the detector unit, in particular for controlling the laser source, the imaging system and the means for selectively directing the illumination beam onto respective portions of the light-receiving surface. The control unit may further be configured to store the acquired images and/or to transmit the acquired images to an external processing unit. To this end, the control unit may comprise a suitable memory device or other data storage device.

The detector unit includes, or is connectable to, a suitable power supply 160 for supplying electrical energy to the laser source and the imaging system. In particular, in some embodiments, the detector unit may include a battery, such as a rechargeable battery.

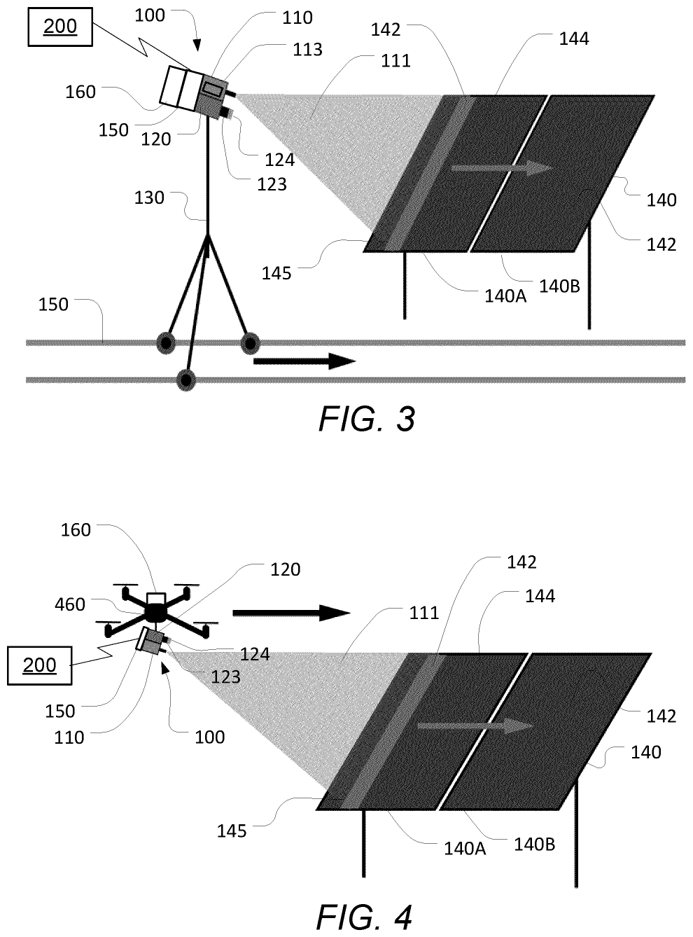

The inspection system of the example of FIG. 1 comprises a tripod 130 on which the detector unit 100 is mounted. It will be appreciated that, in other embodiments, the detector unit may be mounted on another type of support structure, different from a tripod. Examples of alternative support structures may include a frame, a pole, and/or the like. In some embodiments, the detector unit may portable. As will be described in more detail with reference to FIGS. 3-4 below, in other embodiments, the detector unit 100 may be mounted on a vehicle.

Accordingly, an operator may position the detector unit at a distance from a photovoltaic module 140A,B to be inspected. The operator may orient the detector unit such that the PV module to be inspected is located in the field of view of the imaging system and at a suitable distance and orientation from the detector unit so as to allow the detector unit to sweep the illumination beam across the light-receiving surface of the PV module. The detector unit 100 may capture a series of images of the photovoltaic module while scanning or sweeping the illumination beam across the light-receiving surface of the photovoltaic module. In particular, in the present embodiment, the images are taken while the imaging system remains at a fixed position relative to the PV module. Only the illumination beam scans across the light-receiving surface of the PV module. This simplifies the subsequent image processing for combining luminescence data from multiple images into reconstructed images representing consolidated photoluminescence data and/or consolidated induced luminescence data, respectively.

The operator may then move the detector unit and tripod to a different position so as to inspect a different photovoltaic module. In some embodiments, the detector unit may be capable of inspecting multiple PV modules, from a single position.

Once the laser is switched on and the illumination beam impinges on the light-receiving surface of the PV module 140A to be inspected, photoluminescence is generated at the beam position, i.e. in the illuminated portion 143. A portion of the excess carriers from the illuminated portion 143 flows to the non-illuminated portions 145 (illustrated in FIG. 1 as a lighter band 145 on either side of the illuminated line 143) of the partially illuminated PV cells and emit induced luminescence (also referred to herein as contactless electroluminescence or contactless EL). Contactless EL occurs in substantially the entire surface are of the partially illuminated PV cells of the PV module but not in the unilluminated remaining regions 144 of the PV module. Hence, each acquired image reflects first image data indicative of photoluminescence data, and second image data indicative of induced luminescence data from partially illuminated cells. A line profile showing the emitted luminescence along a line perpendicular to the laser line 143 can clearly show the laser beam position on the partially illuminated cell.

The inspection system further comprises a processing unit 200, e.g. a suitably programmed computer or other data processing system. The processing unit 200 is communicatively connectable with the detector unit, e.g. via a wired or wireless data connection, e.g. using radio-communication (e.g. Bluetooth, a cellular telecommunications network or the like) or a suitable wired connection, such as a serial connection, e.g. a USB connection, or a parallel connection. The connection may be a direct connection or via a suitable communications network or multiple nodes. The processing unit 200 is configured to receive the acquired images from the detector unit 100, e.g. after completion of the acquisition of all images or in quasi-real time as the images are acquired, e.g. by live streaming the acquired images from the detector unit to the processing unit. The processing unit stores the received images and processes them so as to generate reconstructed image data from the acquired images, e.g. as will be described in greater detail below. The reconstructed image data is indicative of luminescence emitted by the light-receiving surface responsive to respective portions of the light-receiving surface being illuminated by the illumination beam. It will be appreciated that the processing unit may receive additional data from the detector unit, such as position-data, e.g. data from a GPS device or other suitable positioning device of the detector unit.

FIG. 2 schematically illustrates another example of an inspection system for outdoor, in situ inspection of PV modules. The system of FIG. 2 is similar to the system of FIG. 1, except that the laser source 110 is configured to illuminate a small dot-shaped portion 143 of the light-receiving surface of the PV module. Accordingly, the means for selectively directing the illumination beam onto respective portions of the light-receiving surface may include a 2-axis laser scan mirror 212 or another suitable device allowing a 2-dimensional scanning of the illuminated portion 143 across the light-receiving surface 142 of the PV module. Accordingly, in the example, of FIG. 2, only a single cell is partially illuminated by the laser dot 143 at any given time. Accordingly, contactless EL only occurs in the unilluminated portion 145 of the single partially illuminated cell. The example of FIG. 2 may be predominantly suitable for recording only the induced luminescence in the unilluminated portions 145 while the embodiment of FIG. 1 may be preferable when recording photoluminescence of the illuminated portion as well as the induced luminescence of the unilluminated portions. In the embodiment of FIG. 2, the laser beam may be scanned over of the cells of the module 140A to be inspected, e.g. by means of a 2-axis mirror. Few images recorded per cell while the laser dot is positioned over said cell may be sufficient. However, the dot will be scanned over every single cell to form a final induced EL image of the entire module.

FIG. 3 schematically illustrates yet another example of an inspection system for outdoor, in situ inspection of PV modules. The system of FIG. 3 is similar to the system of FIG. 1, except that the detector unit 100 is mounted on a support that is movable during the scanning operation. In particular, the support 130 is mounted on rails 150 or other type of guide that allows the detector unit to be moved along a direction parallel to the light-receiving surface of the PV module. Accordingly, in this embodiment, the laser scanning mirror may be omitted. Instead, the means for selectively directing the illumination beam onto respective portions of the light-receiving surface include a vehicle, such as a car or dolly, that is movably mounted on a guide allowing one-dimensional motion of the detector unit relative to the PV module. It will be appreciated that a system as shown in FIG. 3 may also be used in combination with the system of FIG. 2. For example, scanning of the illuminated spot may be caused by a linear motion of the dolly and a linear scan of the laser spot, e.g. by a suitable scanning mirror.

FIG. 4 schematically illustrates yet another example of an inspection system for outdoor, in situ inspection of PV modules. The system of FIG. 4 is similar to the system of FIG. 1, except that the detector unit 100 is mounted on a hexacopter or other type of drone 460. The detector unit may have its own battery or be powered by the drone battery. Similarly, the detector unit may share additional functionality with the drone, e.g. a wireless data communications interface or a positioning system or a visual camera for flight control.

When mounted on a drone, the selective direction of the illumination beam onto the light-receiving surface of the PV module may be performed in different ways.

In some embodiments, the detector unit may include a scan mirror as described in connection with the embodiment of FIG. 1. Accordingly, during operation, the drone may be controlled to maintain a substantially fixed position relative to the PV module while the detector unit controls the mirror to scan the illumination beam across the light-receiving surface of the PV module to be inspected.

Alternatively, the scanning of the laser beam across the light-receiving surface of the PV module may be performed by mounting the laser source and, optionally, the imaging system onto a gimbal of the drone. Accordingly, during operation, the drone may be controlled to maintain a substantially fixed position relative to the PV module while the gimbal is controlled to scan the illumination beam across the light-receiving surface of the PV module to be inspected.

Yet alternatively, the scanning of the laser beam across the light-receiving surface of the PV module may be performed by flight operations of the drone, e.g. by controlling the drone to fly along a suitable flight path, e.g. a substantially linear flight path, relative to the PV module, i.e. similar to the scanning operation described in connection with FIG. 3.

It is an advantage of the drone-based embodiment that a fast and largely automatic inspection may be achieved.

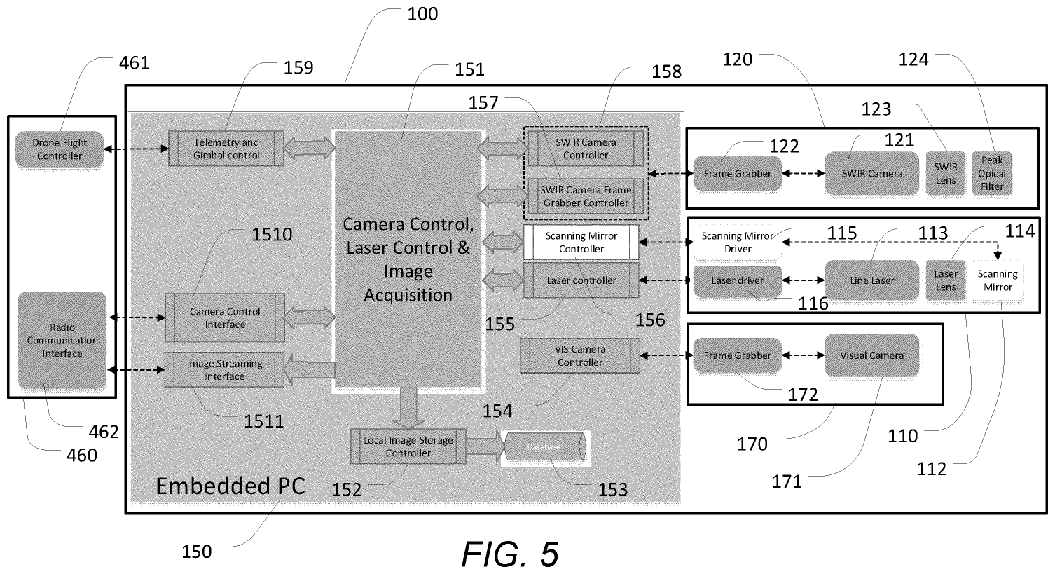

FIG. 5 schematically illustrates an example of a detector unit of an inspection system for outdoor, in situ inspection of PV modules.

The detector unit 100 comprises a laser source 110, an imaging system 120 and a control unit 150. Optionally, the detector unit further comprises an additional imaging system, such as a visual imaging system 170.

The imaging system 110 comprises an SWIR camera 121, an SWIR Lens 123, a peak optical filter 124 and an SWIR camera frame grabber 122. The SWIR camera may be an InGaAs camera. A high resolution camera is preferred for obtaining high-quality image data such as 640×512 pixels or more, e.g. 1280×1024 pixels or more, or even higher. In some embodiments, the camera sensor should preferably have at least 70%, preferably more, quantum efficiency in the peak of crystalline silicon luminescence spectrum, e.g. in the wavelength range of 1130-1150 nm. When the camera detector has a high frame rate, efficient scanning may be obtained. In practice frame rates between 25 to 60 fps have been found suitable, though other frame rates are possible as well. Some embodiments of the camera detector may have exposure times between 17 to 40 ms. However, other exposure times may be used as well. Exposure times smaller than 1 ms allow more flexibility for outdoor applications, for example daylight light-induced luminescence imaging.

The SWIR lens 123 is configured to image the surface of a PV module onto the light sensitive detector of the SWIR camera. The peak optical filter may be configured to selectively allow only light of the luminescence wavelength range of the PV module pass. Preferably, the peak optical filter is configured to only let a wavelength range around the peak luminescence wavelength of the PV module path. In one embodiment, the peak optical filter only allows light of wavelengths between 1000 nm and 1300 nm, such as 1100 nm and 1200 nm, or an even narrower band, pass. When the inspection is performed in low-light conditions, e.g. during night time, the peak optical filter may be chosen to be a longpass filter. For daytime inspection a bandpass filter may be preferable in order to avoid noise from sunlight. In the latter case more images may have to be captured.

The laser source 110 comprises a laser 113 and a laser lens 114 for directing the illumination beam as a line towards the PV module. To this end, the laser lens may be a cylindrical lens. The laser source further comprises a laser driver 116 for controlling operation of the laser 113. Optionally, the laser source further comprises a scanning mirror 112, and accompanying scanning mirror driver 115 for causing the illumination beam emitted by the laser to be scanned or swept across the slight-receiving surface of the PV module to be inspected. It will be appreciated that a scanning mirror may be omitted in embodiments where the scanning operation is performed by movement of the laser source, e.g. when the laser source is mounted on a gimbal or other movable member or when the scanning operation is performed by moving the entire detector unit along a motion path relative to the PV module, e.g. as described in connection with FIG. 3 or FIG. 4. The laser may further comprise a shutter so as to allow the illumination beam to be selectively activated and deactivated without the need of switching the laser on and off.

The laser 113 may be a diode laser, such as a broad area laser diode or a tapered diode laser. Laser diodes have generally have low weight and high power efficiency; broad area laser diodes, in particular, provide high power output while being technologically matured. When the laser is configured to emit a laser beam at wavelengths between 800 and 1050 nm, the wavelength of the laser beam matches with the maximum spectral response of the solar cells, thus increasing efficiency. However, any laser source providing wavelengths between 400 and 1050 nm may be suitable, e.g. in the range from 600 to 1000 nm. In some embodiments, it may be useful when the laser source allows the laser line fan angle to be adjustable.

The visual imaging system 170 comprises a visual camera 171 and an accompanying frame grabber 172. The visual camera is configured such that it has a field of view which is overlapping, if not substantially identical, with the field of view of the SWIR camera 121. The detector unit may be configured to feed images captured by the visual camera to a display of an operator control panel, so as to allow an operator to manually control positioning of the detector unit relative to the PV module or to at least verify proper positioning, e.g. prior to activating the laser source. Alternatively or additionally, when the detector unit is mounted on a self-propelled ground or aerial vehicle, the vehicle may be configured to perform an autonomous or at least semi-autonomous positioning based at least in part on the images captured by the visual camera. In some embodiments, the detector unit may process the images captured by the visual camera and/or by the SWIR camera in order to verify suitable positioning of the detector unit relative to the PV module prior to activating the laser source. In some embodiments, the detector unit may be configured to process the images captured by the visual camera and/or by the SWIR camera in order to detect objects other than the PV module between the detector unit and the PV module, in particular objects intercepting the beam path of the illumination beam. Responsive to detecting such objects, the detector unit may be configured to automatically deactivate the illumination beam.

The control unit 150 may be embodied as an embedded PC or other suitable processing unit.

The detector unit 100 of FIG. 5 is for use as a payload of a drone 460 or other self-propelled vehicle. Accordingly, the control unit may interface with the drone flight controller 4610 (or another vehicle motion controller) and with the radio communication interface 462 of the drone or other vehicle. It will be appreciated that other embodiments of a detector unit, e.g. the detector unit of the system of FIG. 1 may include its own communications interface and/or may not need to interface with any drone flight controller.

The control unit 150 may include a CPU or other suitable processing unit, and a memory. The control unit may be programmed to perform various control functions. In particular, the control unit may execute a main control process 151 for image acquisition and for laser camera control. The main process may interface with additional control processes, such as an SWIR Camera controller 158, an SWIR frame grabber controller, a laser controller 155, a scanning mirror controller 156, a telemetry and gimbal controller 159, a (remote) camera control interface 154, a visual camera controller 154, an image streaming interface 1511 and a local image store controller 152 for storing acquired images in a local database 153.

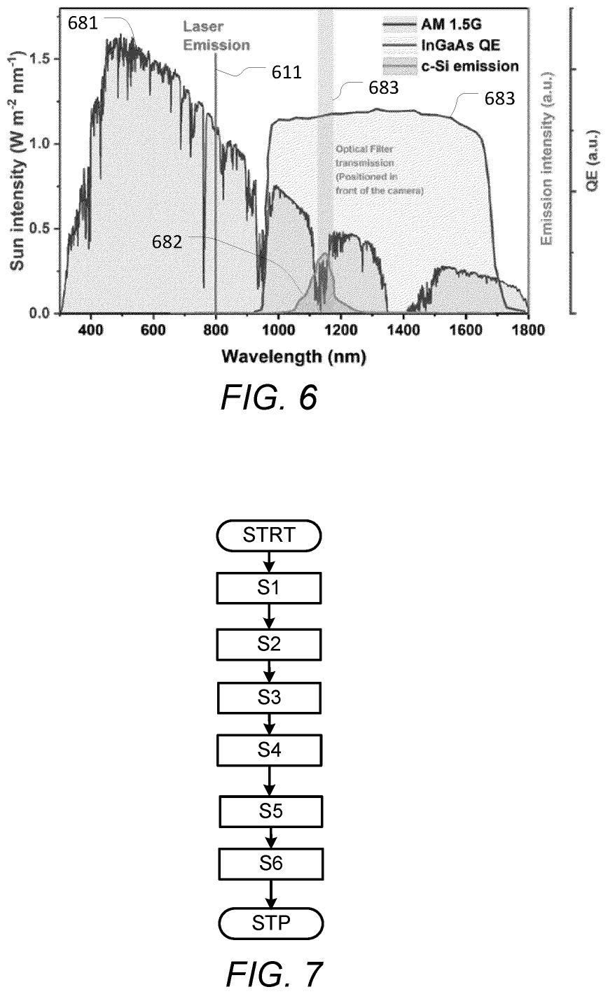

The wavelength of the emitted illumination beam and the sensitivity of the imaging system are preferably selected in accordance with the emission characteristics of silicon-based PV cells, i.e. of typical PV cells, e.g. as illustrated in FIG. 6.

FIG. 6 illustrates different spectral distributions involved in inspection of PV modules. In one embodiment, the illumination beam 611 has a wavelength of about 808 nm. However, illumination beams having different wavelengths may be used instead. When operating the inspection system during daylight, the PV modules as well as the imaging system will also be exposed to daylight. FIG. 6 illustrates a typical spectral distribution 681 of daylight (Air Mass 1.5 global sun spectrum). Typical luminescence emission spectra of PV modules peak in the range between about 1100 nm and 1300 nm which incidentally roughly coincides with a water absorption dip in the daylight spectrum which lies in the range of 1110-1160 nm. As the typical sensitivity 683 of InGaAs cameras cover a considerably broader wavelength range as the luminescence peak of the PV cells, it is advantageous to employ an optical bandpass filter that only allows radiation of a relatively narrow wavelength range 684 around the peak of the luminescence of the PV cells reach the InGaAs camera, in particular so as to allow the luminescence from the PV modules to be recorded by the camera while blocking a majority of the background radiation from daylight.

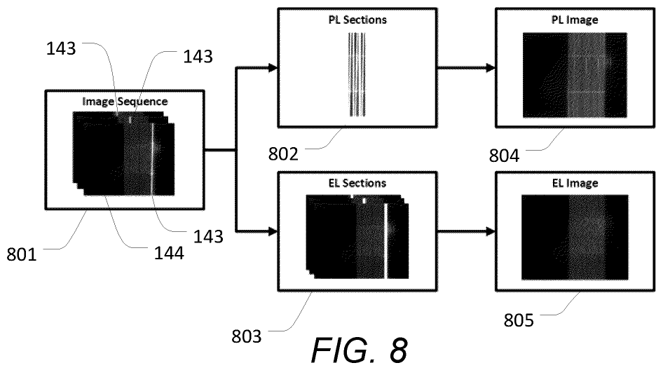

An example of a method for processing the images captured by a detector unit described herein, e.g. by the detector unit of FIG. 5 or the detector unit of any of the systems of FIGS. 1-4, will now be described with reference to FIGS. 7 and 8. In particular, FIG. 7 shows a flow diagram of a method for processing the images captured by a detector unit described herein, and FIG. 8 schematically illustrates steps of a method for processing the images captured by a detector unit described herein. The process may be performed by a suitably programmed data processing system, e.g. a suitably programmed computer. In some embodiments, the process is performed by an entity different from the detector unit, e.g. by the processing unit 200 illustrated in FIGS. 1-4. To this end, the detector unit may be configured to transmit the images captured by it to the processing unit 200 or to another data processing system. It will be appreciated, however, that some or all of the image processing may also be performed by a processing unit integrated into the detector unit.

Generally, in embodiments of the system described herein, the means for selectively directing the illumination beam onto respective portions of the light-receiving surface may be configured to:
direct the illumination beam onto a first portion of the light-receiving surface and to only illuminate the first portion while leaving a corresponding first remaining portion of the light-receiving surface unilluminated by the illumination beam; and
subsequently direct the illumination beam onto a second portion of the light-receiving surface and to only illuminate the second portion while leaving a corresponding second remaining portion of the light-receiving surface unilluminated by the illumination beam.

In particular, the means for selectively directing the illumination beam onto respective portions of the light-receiving surface may be configured to subsequently direct the illumination beam onto a further one or more portions of the light-receiving surface and to only illuminate the one or more further portions while leaving respective remaining portions of the light-receiving surface unilluminated by the illumination beam, until each portion of the light receiving surface has been illuminated by the illumination beam at least once.

Accordingly, the imaging system may be configured to capture a plurality of images of the light-receiving surface, each of the plurality of images depicting the light-receiving surface with only a respective portion of the light-receiving surface being illuminated by the illumination beam, i.e. where different images of the plurality of images depict the light-receiving surface with respective different portions of the light-receiving surface being illuminated and respective different portions of the light-receiving surface being unilluminated by the illumination beam. In particular the plurality of images includes a first image of the light-receiving surface with only the first portion of the light-receiving surface being illuminated by the illumination beam while the corresponding first remaining portion of the light-receiving surface is unilluminated by the illumination beam. The plurality of images further includes a second image of the light-receiving surface with only the second portion of the light-receiving surface being illuminated by the illumination beam while the corresponding second remaining portion of the light-receiving surface is unilluminated by the illumination beam.

The processing unit is configured to process the plurality of images to compute reconstructed image data. The reconstructed image data may represent a reconstructed image of the light-receiving surface, in particular of the entire light-receiving surface. The reconstructed image may be reconstructed from image data from some, in particular from each of the plurality of images. In particular, the reconstructed image depicts first reconstructed image data of the first portion of the light-receiving surface and second reconstructed image data of the second portion of the light-receiving surface. The first and second reconstructed image data are derived from respective ones of the plurality of images. For example, when the reconstructed image depicts PL image data, the processing unit is configured to derive the first reconstructed image data from at least the first image, in particular from an image portion of the first image depicting the illuminated first portion. The processing unit is further configured to derive the second reconstructed image data from at least the second image, in particular from an image portion of the second image depicting the illuminated first portion.

Alternatively, when the reconstructed image depicts EL image data, the processing unit is configured to derive the first reconstructed image data from at least one of the plurality of images different from the first image, in particular from an image portion of said at least one image depicting the first portion when not being illuminated by the illumination beam. The processing unit is further configured to derive the second reconstructed image data from at least one of the plurality of images different from the second image, in particular from an image portion of said at least one image depicting the second portion when not being illuminated by the illumination beam.

In any event, the processing unit may be configured to compute the reconstructed image data by combining multiple images of the plurality of images, i.e. images in which different portions of the light-receiving surface are illuminated by the illumination beam and different portions remain unilluminated by the illumination beam.

Now turning to the process illustrated in FIG. 7, in initial step S1, the process receives a sequence of images captured by the imaging system of the detector unit. An example of such a sequence is schematically illustrated by the sequence of images 801 shown in FIG. 8. In particular, each of the images shows the light receiving surface of a PV module to be inspected. It will be appreciated that each of the images may show the entire light-receiving portion or only a part of the light-receiving portion of the PV module. All images of the sequence show at least one region of the light-receiving surface of the PV module to be inspected that is depicted in all images. Each image shows an illuminated portion 143, illuminated by the illumination beam from the detector unit, and an unilluminated remaining portion 144. Only a part of the unilluminated portion, in particular the unilluminated portions 145 of the PV cells that are partially illuminated by the laser beam also emit luminescence, while the remaining unilluminated portions of the module, i.e. the cells that are not illuminated by the laser beam at all, do substantially not emit any luminescence. When the illumination beam is line-shaped, the illuminated portion has the form of a narrow stripe as in the example of FIG. 8. The images of the sequence of images show the light-receiving surface of the PV module with respective portions of the surface being illuminated, i.e. with the illuminated portion being located at different positions within the light-receiving surface of the PV module.

Generally, embodiments of the inspection system described herein excite only an illuminated portion of the light-receiving surface with a laser. The imaging system of the detector unit acquires a spatially-resolved photoluminescence image of the illuminated portion. The detector unit scans the illumination beam across the light-receiving surface of the PV module to be inspected. The processing unit then performs image processing on the sequence of images to map the entire light-receiving surface of the PV module.

In a part of the unilluminated portions of the surface (namely the unilluminated parts of the partially illuminated PV cells) that are captured in the respective images during the scanning operation, contactless EL occurs due to optically excited excess carriers that induce lateral currents in the PV cell. When the excitation light from the illumination beam is localized to a small region of the cell, contacting and conducting structures (emitter and base), and the metal contacts (grids and busbars) allow the induced charge carriers to spread to the rest of the cell. Some of these charge carriers will recombine radiatively, and to emit photons, causing the non-illuminated portions of the cell to luminesce, similar to what would result from conventional EL imaging by carrier injection. In the luminescence signal, the rate of spontaneous emission via band-band transitions is directly linked to physical quantities such as the product of electron and hole densities, the minority carrier lifetime, the splitting of the quasi-Fermi energies, and the diode voltage.

In subsequent steps, the process combines multiple images, i.e. images in which different portions of the light-receiving surface are illuminated by the illumination beam. In particular, when the illumination beam is line-shaped or a spot/are, the illuminated line or spot/area is located at different positions on the light-receiving surface.

Generally, the sequence of images may be combined in different ways in order to reconstruct image data that reflects the photoluminescence of the illuminated portions and/or the light-induced, contactless electroluminescence of the respective unilluminated portions. In one embodiment, the process computes a reconstructed image that reflects a standard deviation of all images of the sequence of captured image, in particular the standard deviation of the overlapping contactless electroluminescence signal originated by the laser scan. The image processing in this case thus stacks the sequence of images with the illuminated beam line at different position on the light-receiving surface of the PV module into one reconstructed image. The thus reconstructed image shows highlighted contactless EL in areas with high series resistance due to cracks or other faults. Contactless EL and PL are both embedded in a standard deviation image.

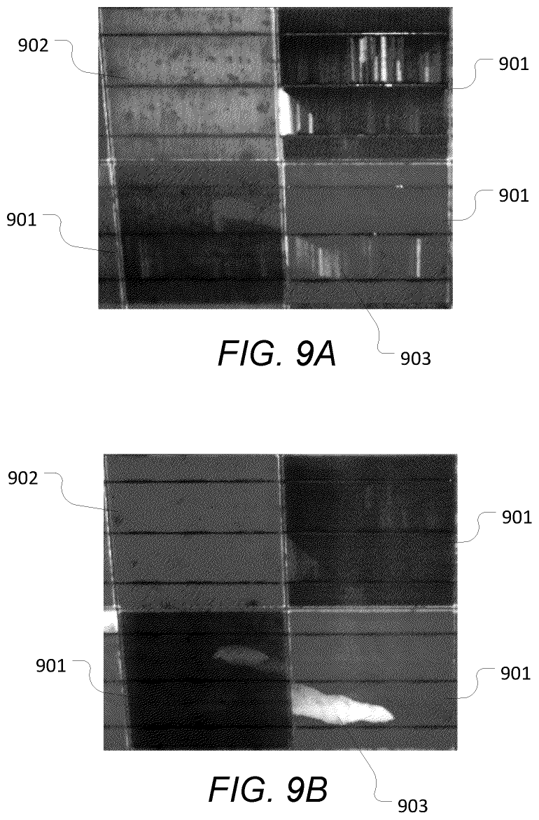

FIGS. 9A-B show examples of reconstructed images representing standard deviations of the sequence of captured images with respective illuminated portions, illuminated by a line laser. In the example of FIG. 9A, the PV module was illuminated with a laser line extending perpendicular to the busbars of the PV module. In the example of FIG. 9B, the PV module was illuminated with a laser line extending parallel to the busbars of the PV module. The images show three regions with defects of different severity and one control region without substantial defects. The images show contactless EL from healthy and cracked areas all overlapped and normalized by the highest luminescence intensity value. Cracked areas and finger failures have higher or lower luminescence signal due to crack/laser orientation.

In FIG. 9A, the laser line illuminated by the laser beam was perpendicular to the busbars, but was parallel to the grid fingers. In several isolated areas (e.g. area 903 which included a cracked area of the PV module), the affected (broken) fingers appear with high relative luminescence signal due to the laser beam orientation. On the other hand, in FIG. 9B, area 903 is the only isolated area that is predominantly highlighted due to the laser beam orientation.

In alternative embodiments, further image processing may be beneficial to allow for a more efficient and reliable identification of defects, in particular of defects having highest severity levels.

To this end, in some embodiments, the process separates the contactless EL and PL image data and reconstruct two or more separate images and/or a segmented image based on the separated PL and contactless EL images.

One embodiment of such a process will now be described with continued reference to FIGS. 7 and 8. In step S2, the process analyses the acquired Image sequence. In particular, the process may determine the luminescence signal available in each image of the sequence. In some embodiments, line, area or other more advanced types of gray value profiles may be computed, analysed and/or used as input data for the following steps.

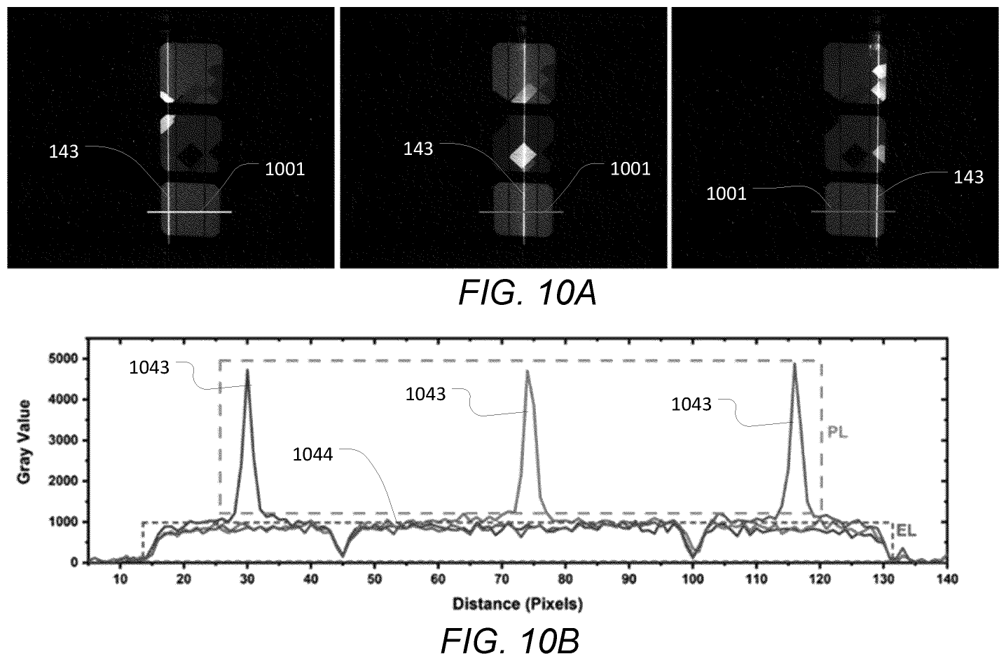

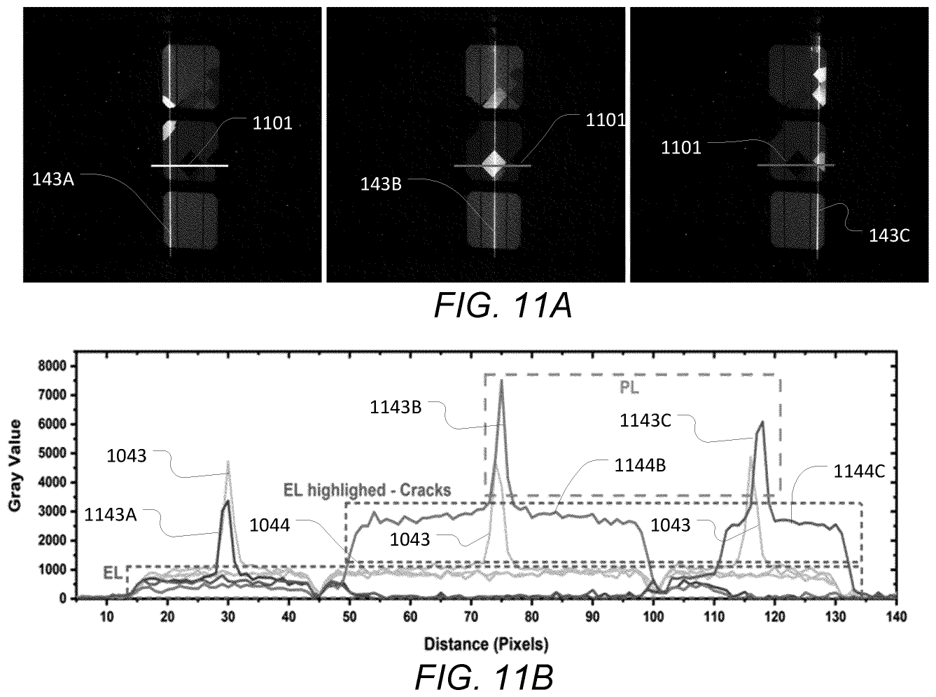

FIGS. 10A-B illustrate an example of such profiles for a healthy PV cell. In particular FIG. shows individual captured images of a PV module with the illuminated laser line 143 located at different positions. FIG. 1013 shows luminescence profiles along a line 1001 perpendicular to the laser line 143. As can be seen, each profile shows a peak 1043 representing the respective positions of the laser line. Moreover, each profile shows a plateau 1045 of elevated luminescence which corresponds to induced luminescence (contactless EL) in a vicinity of the illuminated line 143.

In particular, with the contactless EL gray value 1044 defined for a healthy cell, this value can be used as a reference value for the rest of the module.

For faulty cells, for example cracked cells or cells with high resistance regions, the contactless EL signal will present two or more levels with lower or higher—in the present example higher—luminescence intensity than the one determined for a healthy cell.

FIGS. 11A-B illustrate an example of such profiles for a PV cells having defects. In particular FIG. 11A shows individual captured images of the PV module of FIG. 10A with the illuminated laser line located at different positions 143A, 143B and 143C, respectively. FIG. 11B shows the luminescence profiles of FIG. 1013 with the corresponding peaks 1043 of the profiles across healthy cells. Additionally, FIG. 11B shows corresponding profiles taken along lines 1101 which intersect cell defects. As can be seen from FIG. 11B, in addition to the respective peaks 1143A-C, the detect cells also exhibit an elevated luminescence level 1144B and 1144C, respectively, in the unilluminated area of the defect. These elevated levels will also be referred to herein as “highlighted contactless EL” or simply “highlighted EL”. The highlighted contactless EL may thus be defined by the plateau 1144B, C, respectively, just below the corresponding PL peak 1143B, C, respectively.

FIG. 12 shows corresponding profiles taken for a cracked PV module along line 1201 but for multiple positions of the illuminated laser line. In particular, FIG. 12 shows line profiles of a cracked cell of a full laser line scanning sequence with the laser in 26 different position on the PV cell. To facilitate proper PL image reconstruction, the PL peaks should preferably overlay more than it happens in this example with only 26 different peak positions. This can be achieved by slowing down the scanning speed that in this case was 0.2 m/s while maintaining the same frame rate for the image acquisition. Alternatively or additionally, the frame rate may be increased and/or the exposure time decreased. Nevertheless, contactless EL may successfully be acquired even at this high speed. In one particular example, the inventors have achieved successful results at a frame rate of 60 fps and a scanning speed of 2.5 m/s. However, higher scanning speeds may also be possible.

Again referring to FIGS. 7 and 8, in step S3, the process may segment each of the acquired images. To this end, the process may detect the PL peak or laser beam position (i.e. the position of the illuminated portion of the surface of the PV module which is illuminated by the laser beam) in each of the images of the sequence. Based on this, the process may:
i) Detect any images without luminescence signal; these images may be discarded
ii) Segment the section of the images that contain the PL signal (i.e. laser beam position);
iii) Segment the section of the images that contain contactless EL signal (luminescence from surface portions displaced from the laser beam position).

In FIG. 8, the sections including the PL sections are illustrated as segmented images 802 while the images with the segmented contactless EL signal, i.e. with the illuminated laser line cut out, are illustrated as segmented images 803.

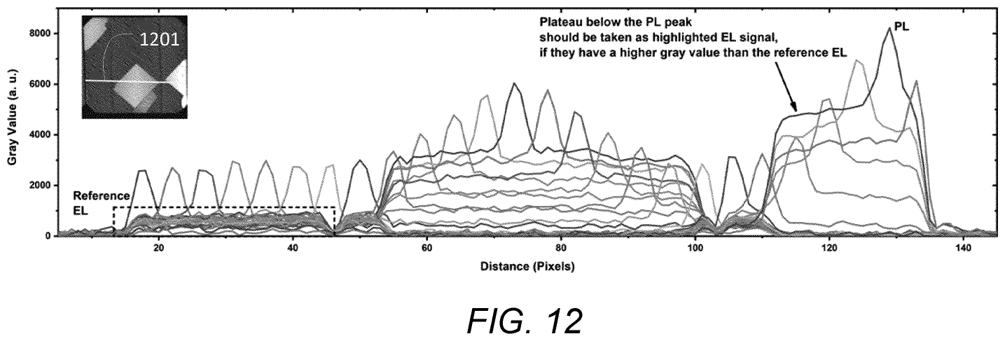

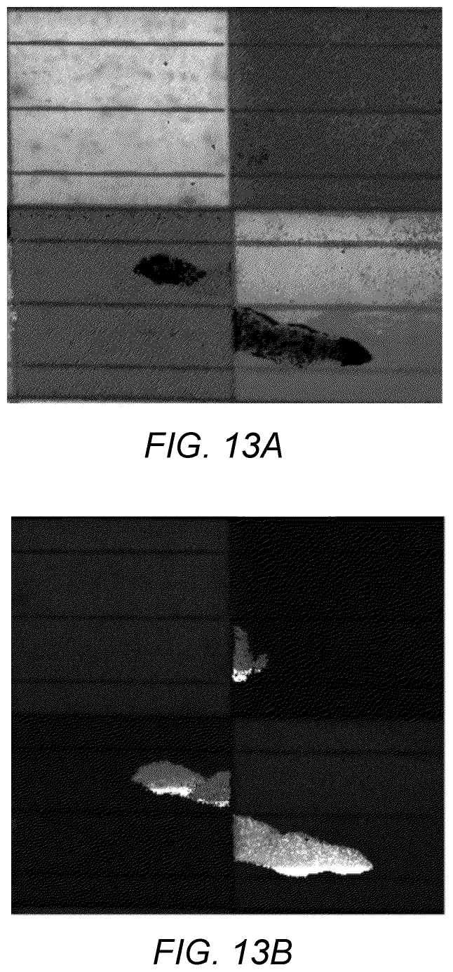

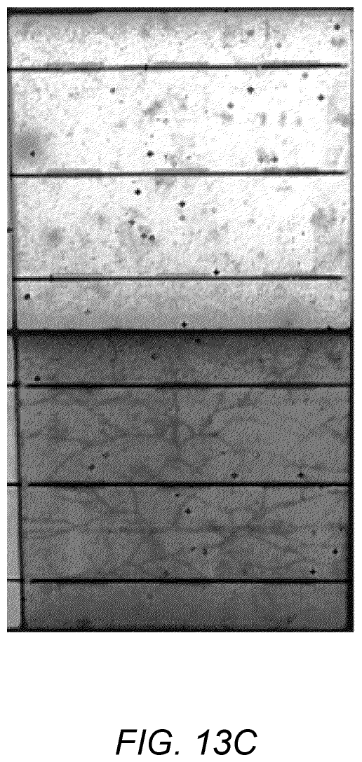

It will be appreciated that other image processing techniques for separating the contactless EL and PL signals may be employed, e.g. without segmentation. For example, in the example of the images shown in FIGS. 13A-B, image processing was performed as follows: The process identifies areas with broadly similar signal statistics, including laser beam profile parameters; range of EL induction—as measured by start and end of the detection of the induced signal in the image stack; as well as positional location in the image. It then scans depth-wise through each pixel of the image stack and investigates local deviation from the broader signal statistics of the enclosing area. Isolated areas and cracks will light up for a longer time than healthy areas, but their expected value will be lower as they are less influenced by the indirect induction. The most important deviations are therefore the expected signal value (or mode) of a pixel, the peak signal value, and the positive signal deviation from the expected laser beam profile.

The resulting deviation statistics of each pixel can then be segmented into interest regions based on proper thresholds.

In step S4, the process determines contactless EL levels of the respective surface regions so as to distinguish between healthy cell areas from faulty cell areas. In particular, faulty cell areas may be detected based on their high intensity contactless EL signal. Accordingly, the process may identify areas with faulty contactless EL levels (e.g. “highlighted EL”) from healthy contactless EL levels (“reference EL” levels) using the data acquired in step S2 and as was explained above with reference to FIGS. 10A-13, 11A-B and 12.

In step S5, the process may perform image reconstruction. In particular, once the respective luminescence signals are analyzed and distinguished, for each signal level a final image may be reconstructed, e.g. one image showing areas with reference contactless EL levels and one image with areas of elevated (“highlighted”) contactless EL levels. In FIG. 8, a reconstructed PL image 804 is shown which corresponds to the individual segmented PL sections being stitched together to form a reconstructed image. Similarly, a reconstructed contactless EL image 805 is shown which corresponds to the individual segmented contactless EL sections being stitched together to form a reconstructed image. Alternatively, two or more contactless EL signal levels may be combined into a single reconstructed image, e.g. using a suitable visible encoding of the different signal levels, e.g. using different colors for different signal levels and/or the like. In some embodiments the process may generate three reconstructed images: one contactless EL image with information similar to traditional EL (e.g. as shown in FIG. 13A), one contactless EL image with highlighted high resistance regions (e.g. as shown in FIG. 13B) and one PL image (e.g. as illustrated in FIG. 13C).

FIGS. 13A-B show examples of segmented images of the PV module shown in FIGS. 9A and 9B. In particular, FIG. 13A shows a signal segmentation of images captured with the laser line oriented parallel to the busbars, where the image is segmented based on a lowest plane of luminescence signal, while FIG. 13B shows a corresponding segmentation based on a highest identified plane of the luminescence signal. As can be seen, these segmented images allow a clear identification of severe defects. FIG. 13A shows results similar to what may be expected from traditional EL at low bias, while FIG. 13B highlights the crack areas with the highest severity. These results can be acquired with very low intensity luminescence signal and reveal important PV diagnosis information.

FIG. 13C shows an example of a PL image. In particular FIG. 13C shows a PL image of the left two cells shown in FIGS. 13A and B. A PL image may show the material related information. In the case of cracks, it may show them without the difference of luminescence level from one side to the other of the image. The PL image may provide interesting information in the case of bad quality silicon material, e.g. due to manufacturing issues or caused by partial shunts, e.g. due to Potential Induced Degradation (PID).

Again referring to FIG. 7, in the final step S6, the process generates the final output for review by an operator. For example, the output may include the reconstructed images and/or other diagnostic information extracted from the reconstructed images and/or the original images. For example, the reconstructed images can be multiplied, subtracted, divided, and/or otherwise combined in order to pinpoint faults or defects in the PV sample.

Additionally, in some embodiments, when stray light or noise from sunlight is involved during image acquisition, modulation of the laser beam may be used for generation of images without luminescence signal in the sequences, i.e. a background image. In this case, the addition of automatic luminescence signal detection, image averaging and subtraction may be beneficial.

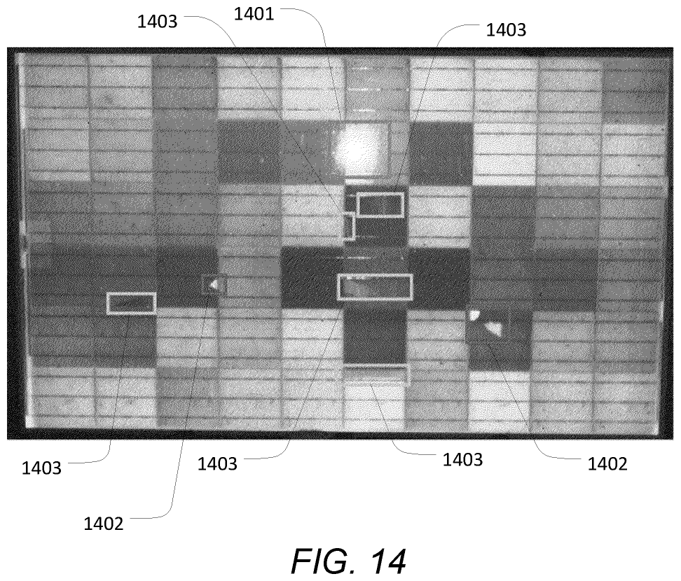

FIG. 14 shows another example of image data reconstructed from acquired images by an embodiment of the system described herein in a test set-up. In particular, FIG. 14 shows an example similar to FIG. 13A except that the example of FIG. 14 shows data for an entire PV module. Different types of defects are identified by boxes. Box 1401 shows reflections from a light source used in the test set-up, i.e. not a defect of the PV module. Boxes 1402 illustrate highly isolated cracked areas while boxes 1403 illustrate isolated cracked areas.

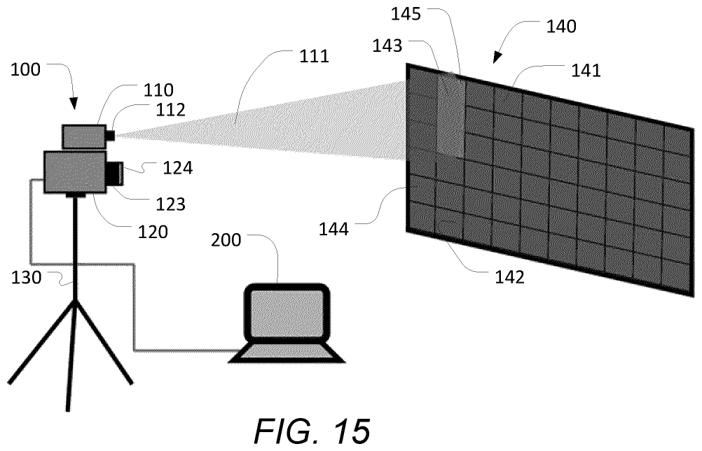

FIG. 15 schematically illustrates another example of an inspection system for outdoor, in situ inspection of PV modules. The system of FIG. 15 is similar to the systems of FIGS. 1 and 2, and the components and features correspond to the components and features identified by the same reference numerals and described in detail in connection with FIGS. 1 and/or 2, except that the laser source 110 of the system of FIG. 15 is configured to illuminate a relatively large spot 143 covering a portion of the light-receiving surface of the PV module. In the present example, the spot is elliptical but other shapes are possible. Accordingly, the means for selectively directing the illumination beam onto respective portions of the light-receiving surface may include a 2-axis laser scan mirror or another suitable device allowing a 2-dimensional scanning of the illuminated portion 143 across the light-receiving surface 142 of the PV module. Alternatively or additionally, the entire detector unit may be moved, e.g. by mounting the detector unit on a movable support or on a vehicle, e.g. as illustrated in FIG. 3 or FIG. 4.

In the example, of FIG. 15, multiple cells are partially illuminated by the laser spot 143 at any given time. Accordingly, contactless EL occurs in the unilluminated portions 145 of each of the partially illuminated cells.

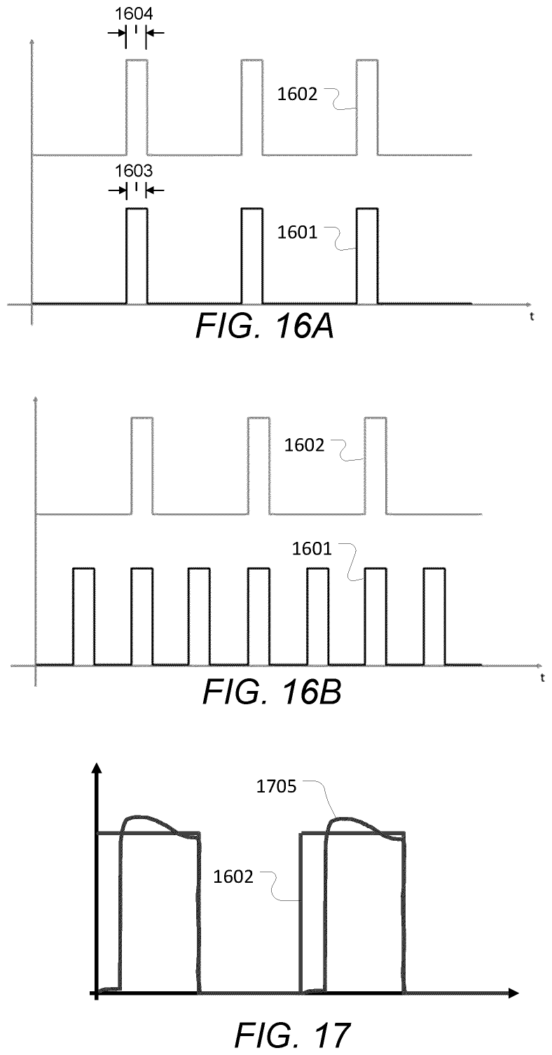

FIGS. 16A-B and 17 schematically illustrate examples of the laser control of an embodiment of the system described herein, in particular of one or more of the embodiments described with reference to the previous figures. In particular, FIG. 16A schematically illustrates an example of a camera exposure trigger signal 1601 and a corresponding example of a laser trigger signal 1602. Accordingly, in the example of FIG. 16A, the camera is triggered to capture images at certain intervals, e.g. at a certain frame rate, and during a certain exposure time 1603. It will be appreciated that, for each illuminated portion, one or several images may be captured. The illumination unit may be controlled to only emit an illumination beam when triggered by the laser trigger signal 1602. In particular the illumination unit may be triggered to only emit an illumination beam when the camera is capturing an image, thus reducing the duty cycle of the laser and the effective average output power, as the laser only emits light during relative short pulses 1604. The pulsing of the illumination beam may be obtained by a shutter or by rapidly switching the laser source on and off. For example, the laser may be operated at a duty cycle between 1% and 70%, such as between 2% and 50%, such as between 3% and 20%, such as between 5% and 10%. FIG. 17 illustrates an example of the laser trigger signal 1602 and the corresponding laser output power 1705. The rising edge of the laser pulses are slightly delayed compared to the rising edge of the trigger pulses. Accordingly, in some embodiments, the laser trigger signal may be selected to slightly precede the exposure trigger, so as to ensure that the laser is turned on during the entire exposure time. In one example, a 40 W laser was operated with a 100 Hz laser trigger signal having 5 ms pulses, corresponding to a 50% duty cycle. The effective laser emission during each cycle lasted about 4.57 ms which corresponds to about 19 W measurable averaged output power.

As mentioned above, in some embodiments, when stray light or noise from sunlight is involved during image acquisition, modulation of the laser beam may be used for generation of images without luminescence signal in the sequences, i.e. a background image. This is illustrated in FIG. 16B where the camera is triggered by signal 1601 more frequently than the laser is triggered by signal 1602, thus allowing automatic luminescence signal detection, image averaging and subtraction.

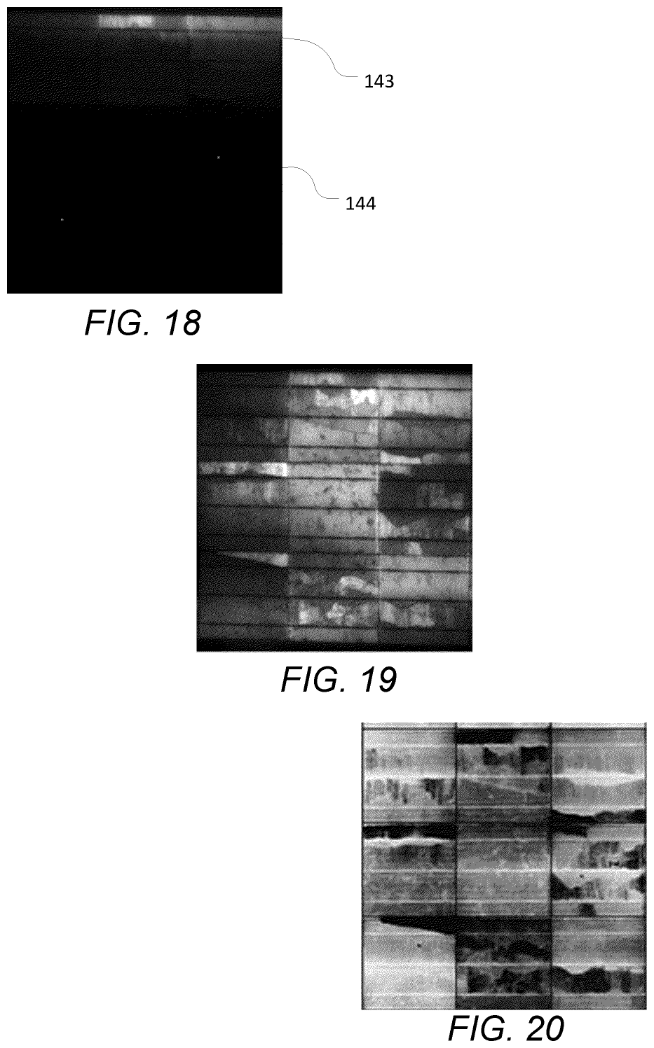

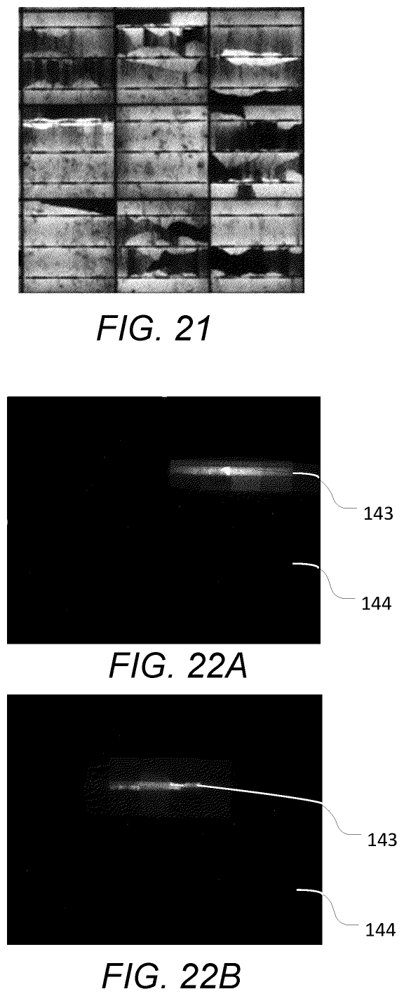

FIG. 18 illustrates an example of a partially illuminated PV module. In particular, FIG. 18 shows the light receiving surface of a PV module to be inspected where a portion 143 of the surface is illuminated by the laser beam of a system as illustrated in FIG. 15 while a remaining portion 144 is unilluminated by the laser beam. In the example of FIG. 18, the laser employed was a 40 W laser illuminating an elongated illumination spot of the light-receiving surface of the PV module. When multiple images of the light receiving surface are captured, each with a different portion of the surface being illuminated, the thus captured images can be combined processed, e.g. as described in connection with FIG. 8 in the context of a line-shaped laser beam. The processing results in a PL image and a contactless EL image as described herein. FIG. 19 illustrates an example of a reconstructed PL image of the PV module of FIG. 18, while FIG. 20 illustrates an example of a reconstructed contactless EL image of the PV module of FIG. 18. Finally, FIG. 21 illustrates a comparative example of a conventional EL image obtained for the PV module of FIG. 18. The combination of PL image information and contactless EL image information may thus be obtained in a single scan of the laser across the PV module. The combination may provide additional diagnosis information compared to only EL information.

FIGS. 22A and 22B illustrate another example of a partially illuminated PV module. In particular, FIGS. 22A and 22B show the light receiving surface of a PV module to be inspected where respective portions 143 of the surface are illuminated by the laser beam of a system as illustrated in FIG. 15 while a remaining portion 144 is unilluminated.

As in the example of FIG. 18, the laser illuminated an elongated illumination spot of the light-receiving surface of the PV module. FIGS. 22A and 22B thus illustrate two images captured during a scan of the laser beam across the light-receiving surface. In the example of FIGS. 22A and 22B, the laser was a 40 W diode laser operated at a current of 30 A, corresponding to approximately 11.4 W output power and pulsed to provide 6 ms pulses.

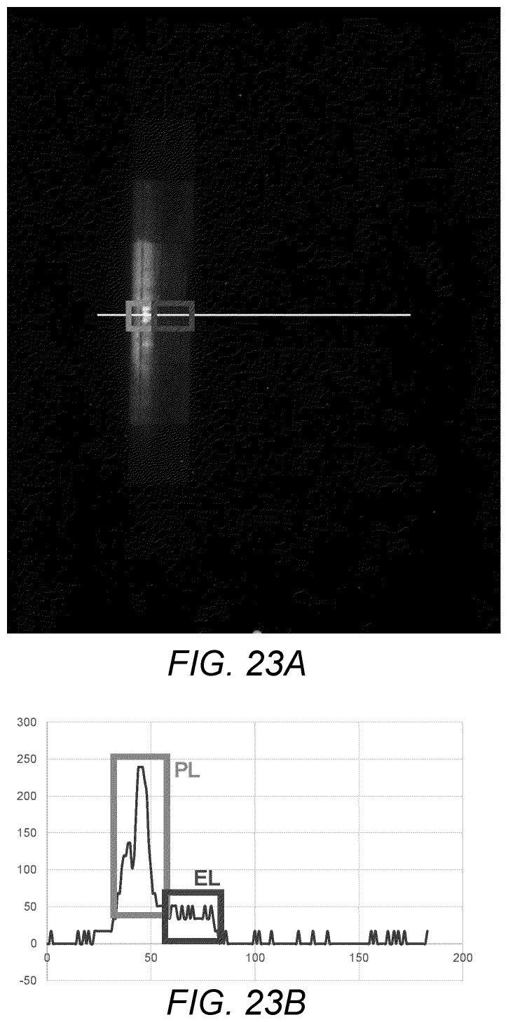

FIGS. 23A and 23B illustrate a recorded light intensity along a line across the partially illuminated light-receiving surface of an image captured as described in connection with FIGS. 22A and 22B. The recorded light intensities allow reconstruction of both PL and EL data as described herein. In particular, FIG. 23A shows a captured image while FIG. 23B shows the recorded intensities along the line illustrated in FIG. 23A.

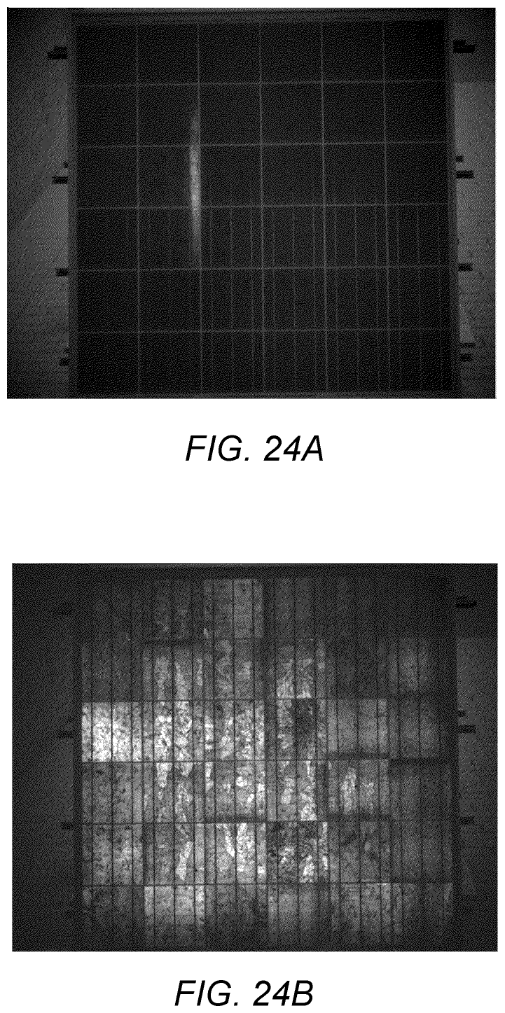

FIGS. 24A and 24B illustrate outdoor operation of the system of FIG. 15. In particular, FIG. 24A shows an example of a captured image during the sweeping of a laser beam across the light-receiving surface of the PV module. In this example, the laser was an 808 nm diode laser operated at an output power of about 41 W, HighGain0, with 1 ms pulses, pulsed corresponding to a camera frame rate of 25 fps. The laser and the camera were positioned at a distance of about 1.7 m from the light-receiving surface. The camera included three OD 4 band-pass and an OD 6 long-pass filter to filter out daylight and other ambient light. The image was captured outdoors in overcast conditions with sun irradiance of about 66 W/m² GHI. FIG. 24B shows an example of a reconstructed image resulting from processing multiple images similar to the one shown in FIG. 24A, where different parts of the light-receiving surface were illuminated by the laser beam. In this example, the reconstructed image reflects a standard deviation of all images of the sequence of captured image.

Embodiments of the method steps described herein as being carried out by a processing unit can be implemented by means of hardware comprising several distinct elements, and/or at least in part by means of a suitably programmed microprocessor. In the apparatus claims enumerating several means, several of these means can be embodied by one and the same element, component or item of hardware. The mere fact that certain measures are recited in mutually different dependent claims or described in different embodiments does not indicate that a combination of these measures cannot be used to advantage.

It should be emphasized that the term “comprises/comprising” when used in this specification is taken to specify the presence of stated features, elements, steps or components but does not preclude the presence or addition of one or more other features, elements, steps, components or groups thereof.

1. An inspection system, in particular a mobile inspection system, for outdoor inspection photovoltaic modules in situ, the inspection system comprising a movable detector unit and a processing unit; wherein the detector unit is configured to obtain, when positioned at a user-controllable position spaced apart from a photovoltaic module, luminescence data from a light-receiving surface of said photovoltaic module; the detector unit comprising: a light source, in particular a laser source, configured to emit an illumination beam; means for selectively directing the illumination beam onto respective portions of the light-receiving surface so as, when the illumination beam is directed onto a first portion of the light-receiving surface, to only illuminate the first portion while leaving a corresponding first remaining portion of the light-receiving surface unilluminated by the illumination beam and, when the illumination beam is directed onto a second portion of the light-receiving surface, to only illuminate the second portion while leaving a corresponding second remaining portion of the light-receiving surface unilluminated by the illumination beam; an imaging system configured to capture a plurality of images of the light-receiving surface, the plurality of images including a first image captured while only the first portion is illuminated by the illumination beam and depicting at least a part of the first illuminated portion and at least a part of the unilluminated first remaining portion, the plurality of images further including a second image captured while only the second portion is illuminated by the illumination beam and depicting at least a part of the second illuminated portion and at least a part of the unilluminated second remaining portion; wherein the processing unit is configured to process the plurality of images to provide reconstructed image data indicative of luminescence emitted by the light-receiving surface responsive to respective portions of the light-receiving surface being illuminated by the illumination beam.

2. A system according to claim 1, wherein the processing unit is configured to process each of the plurality of captured images to separate first image data from second image data from each of the images.

3. A system according to claim 1, configured to cause the means for selectively directing the illumination beam onto respective portions of the light-receiving surface to sweep or scan the illumination beam across the light-receiving surface of the PV module.

4. A system according to claim 1, wherein the illumination beam is a structured illumination beam and/or a line-shaped beam.

5. A system according to claim 1, wherein the illumination beam is configured to illuminate an illuminated spot, in particular a circular, elongated, elliptical or rectangular spot on the light-receiving surface.

6. A system according to claim 1, wherein the illumination beam is a divergent beam.

7. A system according to claim 1, wherein the reconstructed image data is indicative of photoluminescence or induced luminescence data or both.

8. A system according to claim 1, comprising a movable support structure, in particular a tripod or ground vehicle, for supporting the detector unit.

9. A system according to claim 1, wherein the means for selectively directing the illumination beam onto respective portions of the light-receiving surface comprises a movable reflective or refractive element configured to redirect the illumination beam emitted by the light source towards different directions.

10. A system according to claim 1, wherein the detector unit comprises a reference structure and a movable member, movable relative to the reference structure, wherein the light source and, optionally, the imaging system is mounted onto the movable member, wherein the means for selectively directing the illumination beam onto respective portions of the light-receiving surface comprises a drive unit configured to cause movement of the movable member relative to the reference structure.

11. A system according to claim 1, comprising a self-propelled vehicle for supporting the detector unit, and wherein the means for selectively directing the illumination beam onto respective portions of the light-receiving surface comprises a control unit configured to control movement of the detector unit along a motion path relative to the PV module.

12. A system according to claim 1, wherein the light source is configured to emit an illumination beam having an illumination wavelength different from a luminescence peak wavelength of a semiconductor material of the PV module, wherein the imaging system is conjured to image light at least at said luminescence peak wavelength, and wherein the imaging system comprises one or more optical filters configured to allow radiation of said luminescence peak wavelength pass and to block radiation of the illumination wavelength.

13. A system according to claim 1, wherein the detector unit is configured to process at least one image captured by the detector unit so as to recognize a PV module in the captured image and/or so as to detect one or more other objects, different from the PV module, obstructing at least a part of the PV module from view, and to selectively activate and/or deactivate the illumination beam responsive to the detection of the PV module or other object.

14. A system according to claim 1, wherein the detector unit and/or a vehicle on which the detector unit is mounted, includes a positioning system, and wherein the detector unit is configured to associate positioning data to the captured images so as to allow matching the captured images with known positions of respective PV modules within a PV power system.

15. A system according to claim 1, wherein the light source is configured to emit pulsed light.

16. A system according to claim 15, wherein the light source is configured to emit pulsed light having a pulse rate smaller than or corresponding, in particular equal, to a frame rate of the imaging system, and wherein the pulses of the laser light are aligned with the exposure times of the imaging system.

17. A system according to claim 15, wherein the light source is configured to emit pulsed light having a pulse rate smaller than the frame rate of the imaging system, and wherein the system is configured to use images acquired without illumination from the light source for background detection and/or elimination.

18. A method for outdoor inspection of photovoltaic modules in situ, in particular whilst the photovoltaic modules are connected in a PV string, the method comprising: positioning a detector unit spaced apart from a photovoltaic module; selectively directing an illumination beam emitted by a light source of the detector unit onto respective portions of the light-receiving surface so as, when the illumination beam is directed onto a first portion of the light-receiving surface, to only illuminate the first portion while leaving a corresponding first remaining portion of the light-receiving surface unilluminated by the illumination beam and, when the illumination beam is directed onto a second portion of the light-receiving surface, to only illuminate the second portion while leaving a corresponding second remaining portion of the light-receiving surface unilluminated by the illumination beam; capturing, by an imaging system of the movable detector unit, a plurality of images of the light-receiving surface, the plurality of images including a first image captured while only the first portion is illuminated by the illumination beam and depicting at least a part of the first illuminated portion and at least a part of the unilluminated first remaining portion, the plurality of images further including a second image captured while only the second portion is illuminated by the illumination beam and depicting at least a part of the second illuminated portion and at least a part of the unilluminated second remaining portion; processing the plurality of images to provide reconstructed image data indicative of luminescence emitted by the light-receiving surface responsive to respective portions of the light-receiving surface being illuminated by the illumination beam.

19. (canceled)
